(19) United States
(12) Patent Application Publication
(10) Pub. No.: US 2020/0215623 A1
(43) Pub. Date: Jul. 9, 2020

(54) WOODWORKING MACHINERY FLIP STOP SYSTEMS AND METHODS

(71) Applicant: Mark A. Duginske, Merrill, WI (US)

(72) Inventor: Mark A. Duginske, Merrill, WI (US)

(21) Appl. No.: 16/729,156

(22) Filed: Dec. 27, 2019

Related U.S. Application Data
(60) Provisional application No. 62/785,294, filed on Dec. 27, 2018.

(51) Int. Cl. B23B 47/28

(52) U.S. Cl. CPC B23B 47/28

(57) ABSTRACT

Jigs and fixtures for aligning, guiding, and/or holding a workpiece on woodworking machinery during a woodworking operation are described, as well as methods of making, modifying, and using jigs and fixtures.

### CROSS-REFERENCE TO RELATED APPLICATIONS

This application claims priority under 35 U.S.C. § 119 to U.S. Provisional Patent Application No. 62/785,294 filed on Dec. 27, 2018, the entire contents of which are incorporated herein by reference.

### STATEMENT CONCERNING FEDERALLY SPONSORED RESEARCH OR DEVELOPMENT

Not applicable.

### FIELD OF THE INVENTION

This invention relates to jigs and fixtures for aligning, guiding, and/or holding a workpiece on woodworking machinery during a woodworking operation.

### BACKGROUND OF THE INVENTION

Woodworking machines utilize various means of positioning or securing a workpiece as it is cut, drilled, or routed. As standard equipment, a pocket hole jig is not fitted with a stop system for measuring the board location or for securing the workpiece in the desired location. A position stop can help ensure a repeatable location of the workpiece boards in relationship to the drill bit or cutter. A flip stop, which is rotated out of the way when not in use, also establishes a consistent workpiece location. The benefit of this technique is that the operator knows that the edge of the board being drilled is accurately positioned. The accuracy of processing multiple pieces is improved with a stop system.

In addition, U.S. Pat. Nos. 5,337,641; 5,617,909; and 5,768,966, the disclosures of which are hereby incorporated by reference as if fully set forth herein, disclose improved jigs and fixtures for aligning, guiding, and/or holding a workpiece as it is worked, for example as it is cut, drilled, or routed. While the jigs and fixtures disclosed in U.S. Pat. Nos. 5,337,641; 5,617,909; and 5,768,966 represent a significant advance in the art, room still exists for improvements, particularly in the following respects, among others.

Although there are a number of manufactures of stop fences, two examples include those offered by KREG (e.g., see, U.S. Pat. No. 7,464,737) and by INCRA (e.g., see, U.S. Pat. No. 6,557,601). There is not a standard height for the machinery fence, with the height of the INCRA fence being about 3 inches, and the height of the KREG and of the JDS ACCU-MITER (e.g., see, U.S. Pat. No. 5,038,486) fences being about 2.75 inches. The INCRA stop is too long to work with the KREG fence and while, theoretically, the KREG stop may possibly be used with INCRA fence, the T-slot is too wide leaving much to be desired. The original KREG patent utilized tension screws in the stop and in the base for reducing play between the hinge pin, the flip stop, and the base (see U.S. Pat. No. 7,464,737 at FIGS. 8A, 8B, and 8C)—KREG does not use tension screws in the current model of its stop.

Stops are typically secured in a T-slot of a track. There is often a variation, even if slight, in the extrusion that compromises the fit. There is no stop base that fits a variety of T-slots that can be located and be removed from the track between two adjacent stops. U.S. Pat. No. 5,337,641 teaches that the stop can be bolted in the down position, but this requires threading a bolt through the stop into the base, which is tedious. None of the stops available are designed to allow cutting a miter with either the point in or the point out without any manipulation. Expensive stop systems have large and complicated accessories for supporting the point of a miter. Moreover, none of the stops available are designed to accommodate fences of various heights. There is no aftermarket flip stop that has a mechanism for adjusting the length of the stop so that it can be used with fences of different heights. And, none of the stops available are designed to accommodate a removable fixture by simply loosening one knob (or fastener).

### SUMMARY OF THE INVENTION

In some embodiments, the invention provides an improved woodworking machinery jig and fixture system that has a stop with a half-dovetail surface. A miter fixture can be mounted to the accessory slots that has fingers with ends that provide surface support of the mitered end of a workpiece, whether the workpiece is supported with its point toward or away from the working plane of the support.

In other embodiments, a woodworking machinery jig and fixture system may include a universal stop system that fits most machinery fence tracks and may be adjustable for track height and T-slot width without the need for tools. The universal stop described in this application fits on both the INCRA and the KREG machinery, and may accommodate others.

In further embodiments, jigs and fixtures for aligning and positioning a workpiece on woodworking machinery during a woodworking operation are described as well as methods for modifying and using jigs, fixtures, and position stops. Clamp on flip stops for pocket hole jigs are described. A U-shaped clamp on an adjustable stop base is fitted to the pocket hole drill guide for use on a stationary jig or a portable jig.

In some embodiments, the position stops of this disclosure are designed to clamp onto the standard jig without the need for drilling or fabrication. A small flip stop may be fitted to the inside of a rectangular extrusion for use as a measuring device for accurately drilling or sawing a workpiece.

In still further embodiments, a rotatable H-shaped flip stop arm is secured to the end of the base and on the opposite end is a slot that accepts an adjustable bolt; the flip stop arm is configured to contact and accurately position the workpiece. Two generally circular openings in the open space on one side of the H-legs accept a custom configured shoulder bolt that allows the H-frame to rotate mechanically or hang in a naturally angled or skewed position by force of gravity. A flip arm hole fits on the threaded bolt shaft and is locked into the desired position with a thumb nut. A slot on the opposite end of the flip arm accepts an adjustable bolt, nut, and locking thumb nut which can be adjusted to position the location of the workpiece in relationship to the drill bit. A small curved flip stop arm and base are designed to fit inside a rectangular extrusion for accurately positioning the workpiece.

These and other objects and advantages of the invention will be apparent from the detailed description and drawings. In the description, reference is made to the accompanying drawings that illustrate the preferred example embodiments of the invention.

### BRIEF DESCRIPTION OF THE DRAWINGS

FIG. 1A is a perspective view of a KREG portable pocket hole jig with a 15 degree angle fixture attached to a U-shaped fixture clamped to the top of the drill guide. A mitered workpiece board is resting in the jig and is in contact with a triangular-shaped support secured to the floor of the jig.

FIG. 1B is an exploded view of FIG. 1A which is a KREG portable pocket hole jig showing the U-shaped fixture, the 15 degree angled fixture, triangular miter support and the rectangular base which the support is secured to.

FIG. 2A is a dotted line drawing of the triangular miter support showing the slot on the bottom for attaching it to the rectangular support piece.

FIG. 2B is a line drawing showing that the triangular support piece can be rotated 180 degrees and secured from either side.

FIG. 3A is a perspective view of a KREG K4 jig shown from the clamp side of the pocket hole jig with an H-shaped flip stop arm assembly tightened to the U-shaped fixture.

FIG. 3B is an exploded view of FIG. 3A showing a custom made shoulder bolt positioned between the two holes located in the open space between the two H-legs.

FIG. 3C is an enlarged and exploded view of FIG. 3A showing a custom made shoulder bolt positioned between two holes located in the open space between the two L-legs and in contact with the H-shaped stop arm.

FIG. 3D is a quarter inch grid showing the shape of the H-shaped flip stop arm with the location of the threaded portion of the shoulder bolt shown with a solid black circle.

FIG. 4A is an exploded view of a KREG K4 jig shown from the clamp side of the pocket hole jig with an exploded H-shaped flip stop assembly.

FIG. 4B is a view from the thread side of a custom made shoulder bolt positioned between two holes located in the open space between the two L-legs.

FIG. 4C is a view from the knob side of a custom made shoulder bolt positioned between two holes located in the open space between the two flip stop legs.

FIG. 4D is an enlarged view showing a custom made shoulder bolt.

FIG. 4E is a pattern for making the H-shaped flip stop from 0.125 inch material with a laser cutter.

FIG. 5A is a perspective view of a KREG K4 jig shown from the clamp side of the pocket hole jig with an articulating flip stop assembly tightened to the U-shaped fixture on the upright of the jig with a shoulder bolt.

FIG. 5B is an enlarged view showing a custom made shoulder bolt securing the H-shaped flip stop arm to the U-shaped fixture attached to the drill guide.

FIG. 6A is a perspective view of a KREG K4 jig shown from the clamp side of the pocket hole jig with an articulating flip stop assembly tightened to the U-shaped fixture on the upright of the jig with a shoulder bolt. The shoulder of the bolt is smaller than the hole in the H-shaped flip arm and allows the arm to rotate around the bolt. The H-shaped flip arm hangs at an angle and contacts the edge of the panel and thus positions the panel in relationship to the drilling holes.

FIG. 6B is a quarter inch grid showing the shape of the H-shaped flip stop arm with the location of the shoulder portion of the shoulder bolt shown with a solid black circle. It hangs at approximately a 30 degree angle from a vertical orientation.

FIG. 6C is an exploded view of the U-shaped fixture showing the shoulder bolt located through the inside hole of the H-shaped flip stop arm.

FIG. 6D is a perspective view showing the shoulder bolt shoulder located through the inside hole of the H-shaped flip stop arm.

FIG. 6E is a perspective view of a KREG K4 jig shown from the opposite side of the view from FIG. 6A. The outside of the panel is illustrated with a dotted line. The shoulder of the bolt is smaller than the hole in the H-shaped flip arm and allows the arm to rotate around the bolt. The H-shaped flip arm hangs at an angle and contacts the edge of the panel and thus positions the panel in relationship to the drilling holes.

FIG. 7A is a perspective view of a KREG K4 jig showing that the H-shaped flip arm hangs at an angle. As the panel is moved against the drill guide, the hanging flip stop is rotated to a vertical position.

FIG. 7B shows two positions of the flip arm. The angled solid line H is the resting position. The vertical dotted line is the engaged position.

FIG. 7C shows the panel starting to touch the flip stop.

FIG. 7D shows the panel starting to rotate the flip stop.

FIG. 7E shows the panel in position for drilling with the flip stop arm rotated to the vertical position.

FIG. 7F is a quarter inch grid showing the shape of the H-shaped flip stop arm with the shoulder of the bolt shown with a solid black circle.

FIG. 8A is a perspective view of a KREG K4 jig shown with the H-shaped flip stop arm assembly attached to the U-shaped fixture with the shoulder bolt fitted into the outside hole. The adjustable stop bolt is engaged to touch and position the location of the work piece in relationship to the drill guide holes.

FIG. 8B is an enlarged view showing a custom made shoulder bolt securing the H-shaped flip stop arm to the U-shaped fixture attached to the drill guide.

FIG. 8C is a quarter inch grid showing the shape of the H-shaped flip stop arm with the shoulder of the bolt shown with a solid black circle.

FIG. 8D is a diagram showing the rotation of the H-shaped flip stop arm. The solid shape illustrates the engaged position.

FIG. 9A is a perspective view of a KREG K4 jig shown with the H-shaped flip stop arm assembly attached to the U-shaped fixture with the shoulder bolt fitted into the outside hole. The flip stop arm is shown rotated out of the way to the non-engaged position.

FIG. 9B is an enlarged view showing a custom made shoulder bolt securing the H-shaped flip stop arm to the U-shaped fixture attached to the drill guide.

FIG. 9C is a quarter inch grid showing the shape of the H-shaped flip stop arm with the shoulder of the bolt shown with a solid black circle.

FIG. 9D is a diagram showing the rotation of the H-shaped flip stop arm. The solid shape illustrates the non-engaged position.

FIG. 10A is an exploded view of the U-shaped fixture showing the shoulder bolt located through the outside hole of the H-shaped flip stop arm.

FIG. 10B is an enlarged view of FIG. 10A showing a custom made shoulder bolt located in the H-shaped flip stop arm.

FIG. 10C is an enlarged view of FIG. 10A showing a custom made shoulder bolt.

FIG. 11A is an exploded view of the U-shaped fixture showing the shoulder bolt located through the outside hole of the H-shaped flip stop arm.

FIG. 11B is an enlarged view of FIG. 11A showing a custom made shoulder from the knob perspective.

FIG. 11C is an enlarged view of FIG. 11A showing a custom made shoulder from the thread perspective.

FIG. 12A is a perspective view of a KREG K4 jig shown with the panel clamp attached to an arm located vertically from the U-shaped fixture attached to the drill guide with the panel in place.

FIG. 12B is a perspective view of the panel clamp, the vertical arm, and the U-shaped fixture with the panel removed.

FIG. 13A is perspective view of the clamp-on panel frame.

FIG. 13B is an exploded view of FIG. 13A.

FIG. 14A is a perspective view of a KREG K4 jig shown with the panel clamp attached to an arm located vertically from the U-shaped fixture. Located on the vertical arm is the H-shaped flip stop in the engaged angled position.

FIG. 14B is an enlarged view of the flip arm shown in FIG. 14A.

FIG. 14C is a diagram showing the resting position of the H shaped arm with the resting position with a solid line and the rotated position with a dotted line.

FIG. 14D is a perspective view of a KREG K4 jig shown with the panel clamp attached to an arm located vertically from the U-shaped fixture attached. Located on the vertical arm is the H-shaped flip stop in the non-engaged vertical position.

FIG. 14E is an enlarged view of the flip arm shown in FIG. 14C.

FIG. 14F is a diagram showing the resting position of the H-shaped arm with the resting position with a solid line and the rotated position with a dotted line.

FIG. 15A is an exploded view of the U-shaped clamp-on fixture, the vertical arms, and the U-shaped side brackets. The drawing is shown with a quick action clamp.

FIG. 15B illustrates the handle side of the quick action clamp.

FIG. 15C illustrates the lock nut side of the quick action clamp.

FIG. 16A is a perspective view of a clamp side of the KREG K4 jig shown with support boards extending from each side of the jig. On top of the support board is an extrusion with a web that supports a clamp-on flip stop. The drawing shows a panel resting on the jig and support board extrusion with the edge of the panel in contact with the flip stop arm.

FIG. 16B is a perspective view of a drill guide side of the KREG K4 jig shown with support boards extending from each side of the jig. On top of the support boards is an extrusion with a web that supports a clamp-on flip stop. The drawing shows a panel resting on the jig and support board extrusion with the edge of the panel in contact with the flip stop arm. A rotatable H-shaped flip stop arm is attached to the U-shaped fixture surrounding the drill guide. The panel has rotated the H-shaped flip arm to the nearly vertical position.

FIG. 16C is an enlarged view of the flip arm shown in FIG. 16B.

FIG. 16D is an enlarged view of the flip stop arm shown locked on the support board extrusion illustrated in FIG. 16B.

FIG. 17A is a perspective view of a clamp side of the KREG K4 jig shown with support boards extending from each side of the jig. On top of the support boards is an extrusion with a web that supports a clamp-on flip stop. The drawing shows a panel resting on the jig and support board extrusions with the edge of the panel in contact with the flip stop arm. The panel is illustrated with a dotted line.

FIG. 17B is an enlarged view of the flip arm shown in FIG. 17A.

FIG. 17C is an enlarged view of the flip stop arm shown locked on the support board extrusion and in contact with the edge of the panel as illustrated in FIG. 16B.

FIG. 18A is an end view of the support board extrusion.

FIG. 18B is an end view of the flip stop base.

FIG. 18C is an end view of the flip stop arm.

FIG. 18D is an end view of the flip stop arm resting against the workpiece. The arm is rotated at a 3 degree angle from vertical when it is in contact with the workpiece.

FIG. 18E is an end view of the support board extrusion and flip stop base and arm. Gravity holds the flip stop arm in position with the bottom of the flip stop arm resting on a protrusion on top of the L-shaped support board extrusion. In the resting position the flip arm is angled at 40 degrees.

FIG. 18F is an end view of the support board extrusion and flip stop base and arm. The bottom of the support extrusion is extended and material is added at 90 degrees parallel to the table top or auxiliary board. The bottom has a groove that helps locate the position of a screw hole for attaching the extrusion to a table or auxiliary board.

FIG. 19A is a perspective view of a rectangular extrusion that has an angled web that captures the flip arm base.

FIG. 19B is an enlarged view of the flip arm shown in FIG. 19A.

FIG. 19C is an enlarged view of the flip arm shown in FIG. 19B showing the flip arm in the resting and engaged positions.

FIG. 20A is a perspective view of a clamp side of the KREG K4 jig shown with a support board extending from the jig. On top of the support board is an extrusion with a web that supports a clamp-on flip stop. The drawing shows a panel resting on the jig and support board extrusion with the edge of the panel in contact with the flip stop arm. The illustration shows the drill guide removed from its pocket and rotated 180 degrees and held in place with a U-shaped extrusion.

FIG. 20B is an enlarged view of the drill guide and the U-shaped extrusion.

FIG. 20C is an enlarged view of the flip arm shown in FIG. 20A.

FIG. 21A is a perspective view of the clamp side of the KREG K4 jig shown with a vertical leg secured to the U-shaped fixture surrounding the drill guide. A threaded hole in the middle of the vertical leg captures the H-shaped flip arm with a custom made shoulder bolt fitted into the inside hole of the H-frame. The H-flip arm is in the engaged position with its body touching the edge of the panel.

FIG. 21B is an enlarged view of the flip arm shown in FIG. 21A.

FIG. 21C is a perspective view of the clamp side of the KREG K4 jig shown with a vertical leg secured to the U-shaped fixture surrounding the drill guide. A threaded hole in the middle of the vertical leg captures the H-shaped flip arm with a custom made shoulder bolt fitted into the inside hole of the H-frame. The H-flip arm is in the disengaged position with body touching the side of the panel.

FIG. 21D is an enlarged view of the flip arm shown in FIG. 21A.

FIG. 22A is a perspective view of the clamp side of the KREG K4 jig shown with a U-shaped fixture surrounding the reversed drill guide. The panel clamped in the jig is illustrated with dotted lines. The space usually occupied by the drill guide is filled with two identical rectangular extrusions which have an indentation in one corner matching the indentation in the corner of the drill guide.

FIG. 22B is a perspective view of the KREG K4 jig shown from opposite the clamp side. The space usually occupied by the drill guide is filled with two identical rectangular extrusions which have an indentation in one corner matching the indentation in the corner of the drill guide.

FIG. 22C is an explode view of a portion of FIG. 22B.

FIG. 22D is a perspective view of one of the two spacers which are occupying the usual space of the drill guide.

FIG. 23A is an exploded view of the U-shaped clamp-on fixture that secures the drill guide to the clamp plunger.

FIG. 23B is an exploded view of the U-shaped clamp-on fixture that secures the drill guide to the clamp plunger. A slotted groove clamps the head of a toilet bolt which replaces the clamp pad.

FIG. 23C is a clamp pad with a magnet that secures to the head of the toilet bolt. The round clamp pad has round cavity that accepts a round rare earth magnet. Another larger round cavity accepts the oblong head of the toilet bolt as it is attached to the magnet.

FIG. 24A is a perspective view of a table saw shown with a U-shaped fixture surrounding the reversed drill guide which is attached to the De-sta-co style quick action clamp. The panel is sandwiched between the drill guide and the rectangular extrusion illustrated in FIGS. 19 and 20.

FIG. 24B is an enlarged view of the U-shaped clamp-on fixture that secures the drill guide to the clamp plunger.

FIG. 25A is a perspective view of a table saw shown with a U-shaped fixture surrounding the reversed drill guide which is attached to the De-sta-co style quick action clamp. The panel is sandwiched between the drill guide and a custom extrusion that has a leg supporting the clamp-on flip stop as shown in FIGS. 16, 17, and 18.

FIG. 25B is an enlarged view of the flip arm shown in FIG. 25A.

FIG. 25C is an enlarged view of the extrusion shown in FIG. 25A.

FIG. 25D is an enlarged view of the extrusion shown in FIG. 25C.

FIG. 26A is a perspective view of the KREG K4 jig shown with a vertical leg secured to the U-shaped fixture surrounding the drill guide. A round dowel is secured to the bottom of the vertical leg. An extrusion with a round opening fits over the dowel. Another extrusion with a similar design, except for the round opening, is secured with a rectangular extrusion fitted in a T-slot in both extrusions.

FIG. 26B is an enlarged view of the extrusion shown in FIG. 26A.

FIG. 26C is an enlargement of FIG. 26B.

FIG. 27A is an exploded view of the extrusions shown in FIG. 26B supporting a panel.

FIG. 27B is an exploded view of the U-shaped fixture, the vertical leg, the flip arm, and the extrusions for supporting a panel.

FIG. 28A is a perspective view of a table saw fitted with a rectangular extrusion with a flip stop locked to a T-slot. The flip stop is in the engaged position touching the end of the workpiece board.

FIG. 28B is an enlarged view of the extrusion shown in FIG. 28A illustrating the design of the extrusion.

FIG. 28C is an enlarged view of the flip stop shown in FIG. 28A with the flip arm contacting the end of the board.

FIG. 29A is a perspective view of a rectangular extrusion with a flip stop locked to a T-slot. The flip stop in the front of the illustration is in the disengaged position and the flip stop at the back of the illustration is in the engaged position with the flip stop arm in contact with the end of the workpiece. A zero clearance fence is attached to the extrusion.

FIG. 29B is a rotated enlargement of FIG. 29A with the work piece board illustrated with dotted lines.

FIG. 29C is an enlargement of FIG. 29B.

FIG. 30A is the similar set-up as FIG. 27 illustrated on a miter saw.

FIG. 30B is an enlargement of FIG. 30A.

FIG. 30C is an enlargement of the flip stop shown in FIG. 30B.

FIG. 31A is the end view of the rectangular extrusion with an interior T-slot.

FIG. 31B is the end view of the flip stop base extrusion.

FIG. 31C is the end view of the flip stop arm.

FIG. 31D is a view of the stop arm in the open position with gravity holding the flip arm outside the body of the rectangular extrusion.

FIG. 31E is a view of the stop arm in the closed position pushed into the body of the extrusion by the workpiece board.

FIG. 31F is the end view of the stop arm showing both the engaged and disengaged positions with the flip arm illustrated with dotted lines.

FIG. 31G is the end view of the stop arm showing the flip arm resting outside the body of the extrusion.

FIG. 31H is the end view of the stop arm showing the workpieces starting to move the flip arm into the body of the rectangular extrusion.

FIG. 31J is the end view of the flip stop arm showing the workpiece against the extrusion with the flip arm moved into the body of the rectangular extrusion.

FIG. 32A is a perspective view of a rectangular extrusion with a flip stop locked to a T-slot inside a rectangular extrusion. The flip stop is in the open position with gravity moving the flip arm to rest outside the extrusion.

FIG. 32B is an enlargement of FIG. 32A illustrating the rectangular extrusion located inside the rectangular extrusion T-slot.

FIG. 32C is an enlargement of FIG. 32A illustrating the rectangular extrusion located inside the rectangular extrusion T-slot.

FIG. 32D is an exploded view of the rectangular extrusion with multiple flip stops locked to a T-slot. The flip stop is in the engaged position with gravity moving the flip arm to rest outside the extrusion. The nut that fits in the T-slot of the extrusion has been replaced with a rectangular-shaped extrusion that is drilled and tapped to accept the screw head which locks the flip stop base to the extrusion. The tapped extrusion has a hole at 3 inch increments for cutting cabinet rail at 3 inch increments.

FIG. 33A is a perspective view of a table saw shown with multiple flip stops secured to a threaded extrusion as shown in FIGS. 32A and 32B.

FIG. 33B is an enlarged view of the rectangular extrusion with multiple flip stops locked to a T-slot as shown in FIG. 33A. The flip stop is in the engaged position with gravity moving the flip arm to rest outside the extrusion.

FIG. 33C is an enlarged view of the flip stop locked to a T-slot as shown in FIG. 33A.

FIG. 34A is a perspective view of a table saw shown with multiple flip stops secured to a threaded extrusion as shown in FIGS. 32A and 32B. The track shown is an L-shaped extrusion with a curved flip stop attached to the top of the track.

FIG. 34B is an enlarged view of FIG. 34A.

FIG. 34C is an extrusion end view shown in FIG. 31A.

FIG. 34D is an extrusion end view shown in FIG. 31A with the addition of double T-slots as shown with the dotted lines.

FIG. 34E is an extrusion end view with the double T-slot that is added to FIG. 34C.

FIG. 34F is an end view of an L-shaped extrusion and the flip stop extrusions.

FIG. 35A is a perspective view of an L-shaped extrusion with two T-slots on the extrusion and one double T-slot on the side.

FIG. 35B is an enlargement of FIG. 35A showing a V-groove on the inside T-slot which locates the position of a screw hole for attaching the extrusion to an auxiliary fence with a screw.

FIG. 35C is a perspective end view of the L-shaped extrusion and auxiliary fence. An expandable rectangular inside clamp fits in the T-slot and is expandable with a set screw. Expanding the clamp secures the position of the movable ruler.

FIG. 35D is an end view of the L-shaped extrusion showing the expandable clamp and the ruler which fits into a groove on each corner of the T-slot.

FIG. 35E is an enlargement of FIG. 35C.

FIG. 36A is an exploded view of the inside clamp, the ruler, and the set screw for expanding and thus tightening the clamp. The clamp has two identical rectangular halves sandwiched together to make rectangular shape with a tapered slot along one half. A threaded hole in the tapered slot accepts a set screw. As the set screw is threaded into the hole, the two tapered halves expand to apply clamping pressure on the ruler fitted into the slot on the top of the T-slot extrusion opening.

FIG. 36B is an end view of the extrusion, clamp, and ruler illustrated in FIG. 36A showing how the mechanism fits into the T-slot of one of the track extrusions.

FIG. 36C is an enlargement of FIG. 36B.

FIG. 36D illustrates that the spreading clamp is made from a sandwich of two identical injection molded plastic parts. To enhance alignment, the two halves have a positive V-elevation and a negative V-cavity that fit together when the two identical pieces are mated.

FIG. 36E illustrates that the spreading clamp is made from a sandwich of two identical injection molded plastic parts with the threaded hole at a slight incline.

FIG. 36F illustrates that the rectangular spreading clamp is made from a sandwich of two identical injection molded plastic parts. A long tapered V-slot is created by a taper in the two halves. A partial threaded cavity on each half lines up with each other for an opening to accept a set screw.

FIG. 37A illustrates the INCRA table saw miter gauge extrusion with the curved flip stop illustrated in FIGS. 34A, 34B, and 34F.

FIG. 37B illustrates the INCRA table saw miter gauge extrusion with the curved flip stop fitted to an L-shaped extrusion with a double T-slot top and a groove on the opposite leg that fits into a T-slot on the back of the INCRA extrusion.

FIG. 37C is an enlargement of the L-shaped connector bracket shown in FIG. 37B.

FIG. 38A illustrates the INCRA table saw miter gauge extrusion with the INCRA flip stop fitted with a curved extrusion to make it a curved flip stop.

FIG. 38B is an enlargement of the INCRA flip stop and the curved flip stop accessory.

FIG. 38C is an end view of the INCRA flip stop and the curved flip stop accessory.

FIG. 38D is an end view of the INCRA flip stop.

FIG. 38E is an end view of the curved flip stop accessory.

FIG. 39A is a perspective view of a drill press and an auxiliary table to enlarge the working surface fitted with an extruded fence with curved flip stops attached to the extrusion.

FIG. 39B is an enlargement of the curved flip stop accessories.

FIG. 39C is an enlargement of the curved flip stop accessory in contact with the workpiece board.

FIG. 39D is an end view of the fence extrusion illustrated in FIG. 39A.

FIG. 40A is a perspective view of a drill press and an auxiliary table fitted with an extruded fence with curved flip stops attached to the extrusion. The perspective is from the back of the drill press.

FIG. 40B is an enlargement of the extrusion and curved flip stop accessory.

FIG. 40C is an end view of the fence extrusion illustrated with another T-slot extrusion added to it to create a rectangular extrusion.

FIG. 40D is an end view of the fence extrusion illustrated with another T-slot extrusion added to it to create a rectangular extrusion.

FIG. 40E is an end view of the fence extrusion illustrated with another T-slot extrusion added to it to create a rectangular extrusion.

FIG. 40F is an end view of the curved flip stop extrusion.

FIG. 40G is an end view of the flip stop base extrusion.

FIG. 41A is a perspective view of a KREG K 4 pocket hole jig with a clamp on U-shaped fixture that supports an H-shaped swing stop. An adjustment bolt for the stop is held in place by a round magnet that is in contact with the metal base of the clamp. The swing stop arm is attached to the U-shaped fixture with a bolt through a hole in the middle of the swing stop. The stop body is hanging at a 45 degree angle and acts as a position stop with the end of the panel touching the stop arm.

FIG. 41B is an enlargement of the adjusting bolt and magnet shown in FIG. 41A.

FIG. 41C is an enlargement of the flip stop arm shown in FIG. 41A.

FIG. 41D is a quarter inch grid showing the design and size of the flip stop arm.

FIG. 41E is an enlargement of the flip stop arm with the center of gravity illustrated with an arrow.

FIG. 41F is an enlargement of the center of gravity illustrated with an arrow.

FIG. 42A is a perspective view of a KREG K 4 pocket hole jig with a clamp on U-shaped fixture that supports an H shaped flip stop. An adjustment bolt is positioned in the opening at the bottom of the flip stop arm.

FIG. 42B is an exploded enlargement of the adjusting bolt, flip stop arm and the double shoulder bolt.

FIG. 42C is an enlargement illustrating the double shoulder bolt.

FIG. 42D is an enlargement illustrating the flip stop arm assembly.

FIG. 42E is an enlargement of the adjusting bolt and magnet shown in FIG. 41A.

FIG. 43A is a perspective view of a double shoulder bolt.

FIG. 43B is an exploded view of the double shoulder bolt illustrated in FIG. 43A.

FIG. 43C is the perspective view of the thumb nut head.

FIG. 43D is a perspective view of the larger shoulder.

FIG. 43E is a perspective view of the smaller shoulder.

FIG. 43F is a perspective view of the threads of the shoulder bolt.

FIG. 43G is a perspective view of the smaller shoulder fitting into the slot in the flip stop arm.

FIG. 43H is a perspective view of the larger shoulder fitting into the hole in the middle of the flip stop arm.

FIG. 43J is a perspective view of the larger shoulder fitting into the hole in the end of the flip stop arm.

FIG. 44A is a perspective view of a double shoulder bolt.

FIG. 44B is an exploded view of the double shoulder with the small shoulder located in the slot in the body of the flip arm.

FIG. 44C is a perspective view of the flip arm body.

FIG. 44D is a perspective view of the smaller shoulder positioned near the opening into the slot in the flip stop arm.

FIG. 44E is an enlargement of FIG. 44D.

FIG. 44F is a perspective view of the double shoulder bolt with the smaller shoulder located in the slot in the body of the flip arm.

FIG. 44G is an enlargement of FIG. 44F.

FIG. 45A is a perspective view of a double shoulder bolt.

FIG. 45B is an enlargement of FIG. 45A showing the larger shoulder.

FIG. 45C is an exploded view of the double shoulder bolt.

FIG. 45D is an exploded view of the double shoulder with the larger shoulder located in an outside hole in the body of the flip arm.

FIG. 45E is an enlargement of FIG. 45D showing the larger shoulder located in an outside hole in the body of the flip arm.

FIG. 46A is a perspective view of a flip stop attached to a T-slot extrusion mounted on a board. The leg of the flip stop is fitted with a curved extrusion that elevates the flip stop to a standby position when a workpiece board is moved against it.

FIG. 46B is an enlargement of FIG. 46A showing the modified hexagon adaptor that connects the flip stop base to the track extrusion.

FIG. 46C is an enlargement end view of the modified hexagon adaptor that connects the flip stop base to the track extrusion.

FIG. 46D is an end view of the top and bottom of the flip stop base, the modified hexagon adaptor piece, and the track extrusion.

FIG. 46E is an enlargement end view of the modified hexagon adaptor shaped opening in the bottom of the flip stop base.

FIG. 46F is an end view of the top half of the flip stop base.

FIG. 46G is an end view of the bottom of the flip stop base.

FIG. 46H is an end view of the modified hexagon-shaped extrusion that fits into the bottom of the flip stop base.

FIG. 46J is an end view of the T-track the flip stop base mounts to.

FIG. 47A is a perspective view of a flip stop base.

FIG. 47B is an enlarged end view of the V-shaped point on the top member of the flip stop base fitting into a V-shaped notch in the bottom member of the flip stop base.

FIG. 47C is an exploded drawing of a flip stop base.

FIG. 47D is an exploded drawing of a flip stop base showing the modified hexagon shaped adaptor extrusion fitting into the bottom of the flip stop base.

FIG. 47E is an end view drawing of a flip stop base showing the modified hexagon shaped adaptor extrusion. Dotted lines illustrate a parallelogram-shaped member on the top and bottom of the extrusion that are two different sizes.

FIG. 47F is an end view drawing of a flip stop base showing the modified hexagon-shaped adaptor. The length of the larger parallelogram shape is 0.360 inches and the length of the shorter parallelogram is 0.280 inches. The drawing shows the longer parallelogram on the top.

FIG. 47G illustrates the adaptor extrusion being rotated.

FIG. 47H illustrates the adaptor extrusion rotated so that the shorter parallelogram shape is on the top.

FIG. 47J illustrates the adaptor extrusion fitted to a T-slot extrusion with an opening of 0.280 of an inch.

FIG. 47K illustrates the adaptor extrusion fitted to a T-slot extrusion with an opening of 0.360 of an inch.

FIG. 48A is a perspective drawing of a flip stop attached to a T-slot extrusion mounted on a board. The leg of the flip stop is fitted with a curved extrusion that elevates the flip stop to a standby position when a workpiece board is moved against it. One stop is in the engaged position touching the edge of the board. One stop rests on top of the board and is in the stand by position.

FIG. 48B is a perspective drawing of a flip stop shown in FIG. 48A removed from the track.

FIG. 48C is an end view of the flip stop arm extrusion.

FIG. 48D is an end view of the flip leg arm extrusion.

FIG. 48E is an end view of the flip leg curved extrusion accessory.

FIG. 48F is an end view of the L-shaped flip stop arm.

FIG. 49A is a perspective drawing of a flip stop attached to the popular 0.375 inch high T-slot extrusion track. The arm of the flip stop has orient upward away from the track extrusion. The corrugations on the face of the arm engage the match corrugations on the flip stop leg. Slots on the leg and arm allow the two members to be bolted together and secured with a thumb knob.

FIG. 49B is a perspective drawing of a flip stop attached to a T-slot extrusion track which is mounted to a wood fence. The arm of the flip stop has orient upward away from the track extrusion. The corrugations on the face of the arm engage the match corrugations on the flip stop leg.

FIG. 49C is an end view of the L-shaped flip stop arm extrusion shown with the corrugated half pointed down.

FIG. 49D is an end view of the L-shaped flip stop arm extrusion shown with the corrugated half pointed up.

FIG. 49E is an end view of the flip leg arm extrusion.

FIG. 49F is an end view of the L-shaped flip stop arm extrusion shown with the corrugated half pointed up and the leg is positioned for a compact application.

FIG. 49G is an end view of the L-shaped flip stop arm extrusion shown with the corrugated half pointed down and the leg is positioned for an extended application.

FIG. 50A is an illustration of woodworking machines flip stop position on an extruded aluminum fence as a measuring system for a woodworking machine. The adjustable 3-part base which supports the flip stop arm has been described earlier in this application. The flip stop arm is angled at approximately 20 degrees. It is made of two adjustable pieces with mating corrugations on each piece. A bolt in the inside of the angled arm piece passes through a slot in the curved foot and allows the corrugations in each piece to be sighted together into a solid flip stop arm. The curved foot allows the operator to push the workpiece under the stop to elevate it out of the way when measurement of the stop measures is not needed.

FIG. 50B is a perspective illustration of the 3-piece flip stop base.

FIG. 50C is a perspective view of the two pieces of the flip stop arm removed from the fence extrusion and the stop base. The parts are coupled and clamped together with a bolt and a knob.

FIG. 50D is perspective view of the flip stop and the base shown as a unit and removed from the fence extrusion.

FIGS. 51A-D illustrate how the two flip arm members mate with each other and provide height adjustment.

FIG. 51A is an end-view of the stop arm piece shown in FIG. 50A.

FIG. 51B is an exploded end-view of the stop arm pieces shown in FIG. 51A.

FIG. 51C is an end-view of the stop arm pieces shown in FIG. 51A with the two pieces joined in a way to extend the length of the stop arm for use with a high fence.

FIG. 51D is an end-view of the stop arm pieces shown in FIG. 51A with the two pieces joined in a way to shorten the length of the stop arm for use with a low fence.

FIG. 51E is a partial enlarged view.

FIG. 52A is a perspective view of the INCRA miter gauge fence and stop system with base assembly which supports the flip stop arm which is illustrated in FIG. 52B.

FIG. 52B is a detail view of an INCRA flip stop arm.

FIG. 52C is a perspective view that illustrates the adjustable in length self-elevating flip stop design in FIGS. 50 and 51 adapted to INCRA miter gauge fence and stop system. The flip arm is not connected to the INCRA base in this illustration. The two INCRA flip stop arms have been replaced by two curved arms. The curved bottom extrusion is a similar design as shown in FIGS. 51 and 52. The upper connecting extrusion has a similar half oval design as the INCRA flip arm base.

FIG. 52D is an exploded perspective view illustrating the matching corrugations.

FIG. 52E is a modified end-view of the flip stop arm extrusions.

FIG. 52F is an exploded perspective view illustrating the matching corrugations.

FIG. 53A is a perspective view of the universal flip stop attached to the KREG top track. Also show in the illustration is the KREG flip stop. A workpiece is in contact with the curve bottom of the universal stop.

FIG. 53B is a detailed perspective view of the universal stop removed from the fence.

FIG. 53C is a detail perspective view showing a knob for tightening the stop base and the tightening screw for tightening the tension on the stop arm.

FIG. 53D is an end view of the slip stop arm and the clamping top.

FIG. 53E is an enlarged view of FIG. 53D.

FIG. 53F is an enlarged view of FIG. 53E illustrating the gap between the flip stop to and the flip stop arm when the two extrusions are sighted on the bolt.

FIG. 54A is a perspective view of an INCRA fence with two universe stops mounted on the INCRA double T-slot extrusion.

FIG. 54B is an end view INCRA flip stop base on top of the INCRA double T-slot track.

FIG. 54C is an end view of a two-piece stop base positioned on the INCRA double T-slot extrusion.

FIG. 54D is an enlarged end view of the two-piece stop base illustrated in FIG. 54C.

FIG. 54E is an end view of an example embodiment of a two-piece clamp style stop base, similar to the base illustrated in FIG. 46D, depicting one of the bolt holes as larger than the other. For example, the smaller hole may accept and squeeze a ¼ inch bolt and the larger hole may accept and squeeze a 5/16 inch bolt. The example modified hexagon adaptor is shown upgraded so that the extrusion die has rounded corners that can help decrease extrusion die wear.

FIG. 54F is an enlarged view of the modified hexagon adaptor bottom extrusion shown in FIG. 54E illustrating curved corners, which will decrease extrusions die wear.

### DETAILED DESCRIPTION OF THE PREFERRED EMBODIMENT

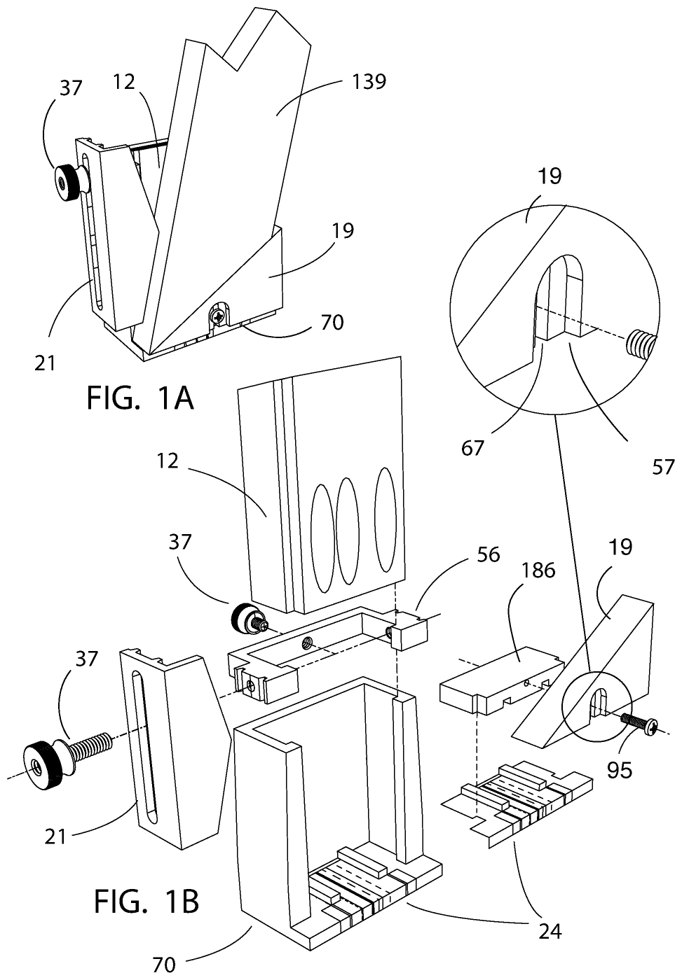

Embodiments of the invention are illustrated in extensive detail in the accompanying FIGS. 1-54, and as set forth above in the description of the accompanying FIGS. 1-54. As shown in the FIGS. 1-54, jigs and fixtures for aligning, guiding, and/or holding a workpiece on woodworking machinery during a woodworking operation are described, as well as methods of making, modifying, and using jigs and fixtures. Given the benefit of this disclosure, various modifications and alterations to the example embodiments described herein will become apparent to one of ordinary skill in the art, such that the scope of the invention is not to be unduly limited to the example embodiments described and illustrated.

FIG. 1A illustrates an example KREG portable pocket hole jig with a 15 degree angle fixture 21 attached to a U-shaped fixture 56 clamped to the top of the drill guide 12. A mitered workpiece board 139 is resting in the jig 10 and is in contact with an example embodiment of a triangular-shaped support 19 secured to the floor of the jig 10. FIG. 1B is an exploded view of FIG. 1A, which is a KREG portable pocket hole jig 10 showing the U-shaped fixture 56, the 15 degree angled fixture 21, the triangular miter support 19, and the rectangular base 186 to which the support 19 is secured.

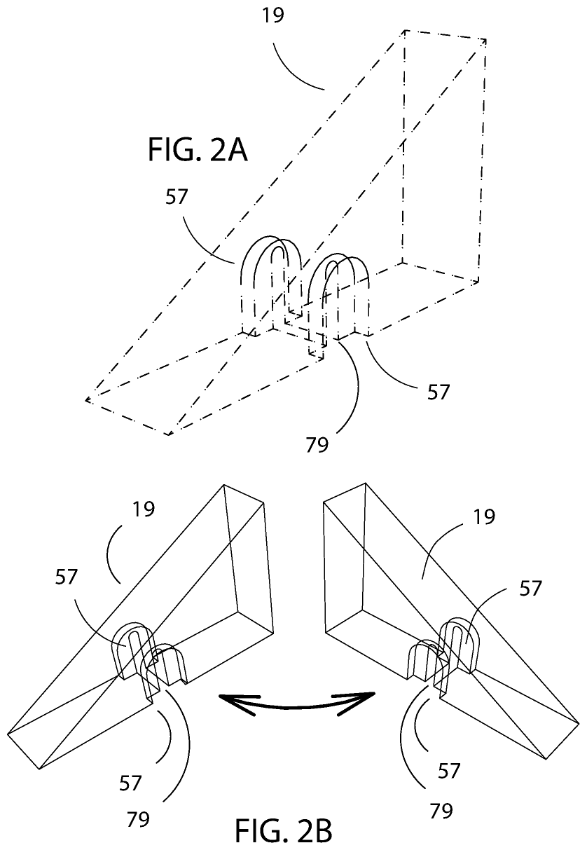

FIG. 2A is a dotted line drawing of the example triangular miter support 19 showing the U-shaped slot 79 on the bottom for attaching it to the rectangular support piece 186. The support 19 also includes a U-shaped groove 57 to accommodate the head of the fastener 95 used to couple the support 19 to the support piece 186. FIG. 2B is a line drawing showing that the triangular support piece 19 can be rotated 180 degrees and secured from either side. The support 19 may take on a variety of different inclines and form factors to accommodate application-specific needs.

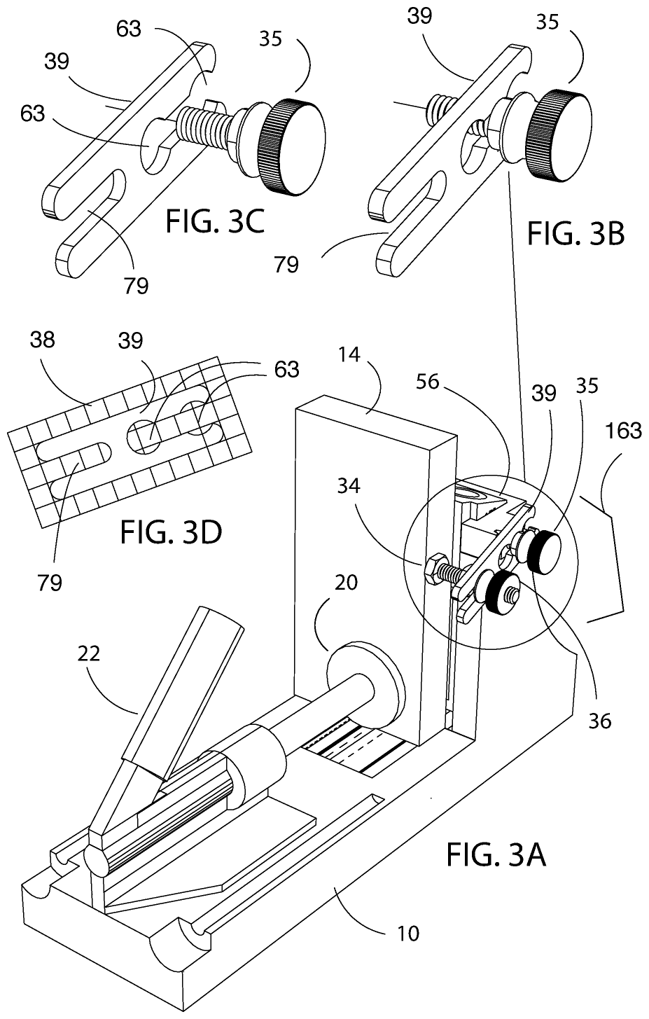

FIG. 3A is a perspective view of a KREG K4 jig 10 shown from the clamp side of the pocket hole jig with an H-shaped flip stop arm assembly 39 tightened to the U-shaped fixture 56. FIG. 3B is an exploded view of FIG. 3A showing a custom made shoulder bolt 35 positioned between the two general holes or openings 63 located in the open space between the two H-legs. FIG. 3C is an enlarged and exploded view of FIG. 3A showing the custom made shoulder bolt 35 positioned between two openings 63 located in the open space between the two L-legs and in contact with the H-shaped stop arm 39. FIG. 3D is a quarter inch grid 38 showing the shape of the example embodiment H-shaped flip stop arm 39 with the location of the threaded portion of the shoulder bolt 35 shown with a solid black circle.

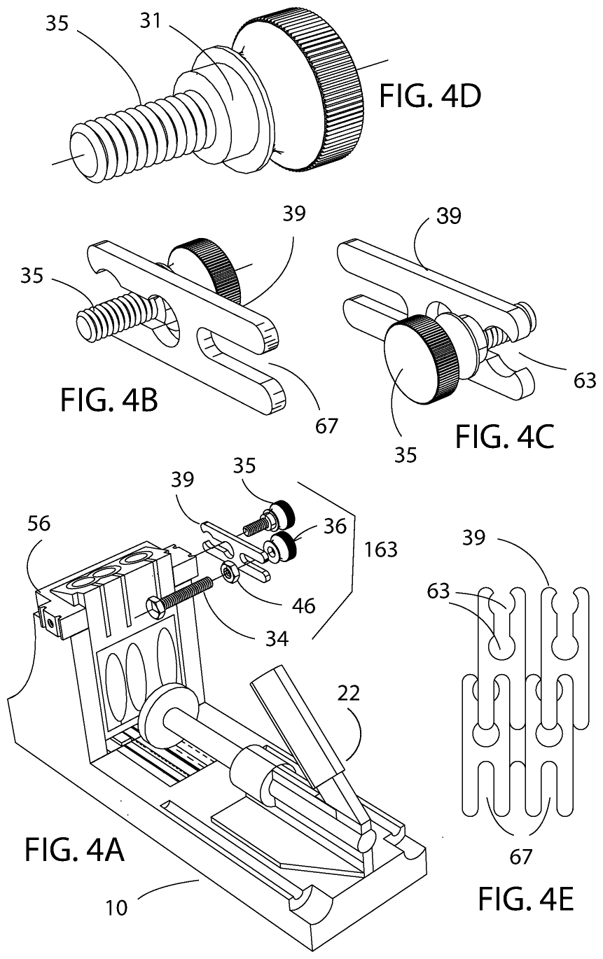

FIG. 4A is an exploded view of a KREG K4 jig 10 shown from the clamp side of the pocket hole jig with an exploded H-shaped flip stop assembly 39. FIG. 4B is a view from the thread side of a custom made shoulder bolt 35 positioned between two openings 63 located in the open space (e.g., the U-shaped slot 67) between the two L-legs. FIG. 4C is a view from the knob side of a custom made shoulder bolt 35 positioned between two openings 63 located in the open space between the two flip stop legs. FIG. 4D is an enlarged view showing a custom made shoulder bolt 35. FIG. 4E is a pattern for making the example embodiment of the H-shaped flip stop from 0.125 inch material with a laser cutter. Of course, as one skilled in the art will appreciate, the flip stop may have a variety of other form factors that achieve the overarching concepts.

FIG. 5A is a perspective view of a KREG K4 jig 10 shown from the clamp side of the pocket hole jig with an articulating flip stop assembly 39 tightened to the U-shaped fixture 56 on the upright of the jig with the example embodiment of the shoulder bolt 35. FIG. 5B is an enlarged view showing the custom made shoulder bolt 35 securing the H-shaped flip stop arm 39 to the U-shaped fixture attached to the drill guide 12.

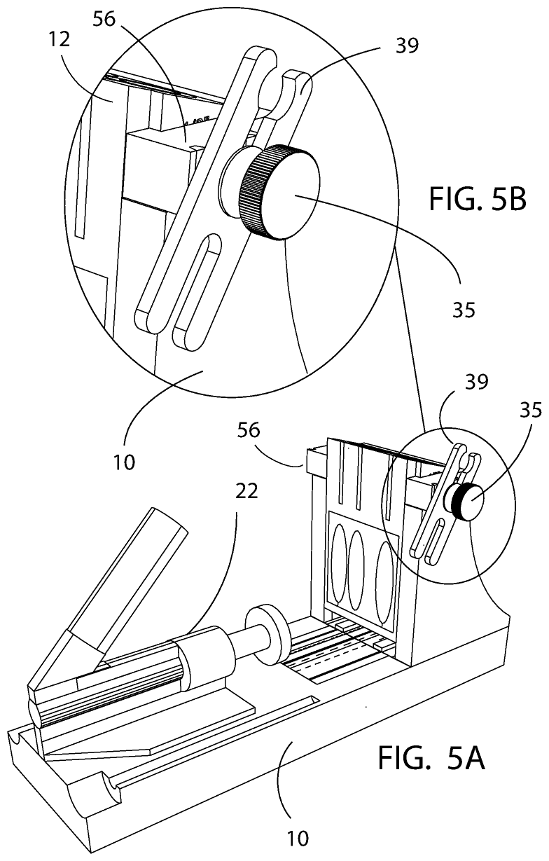

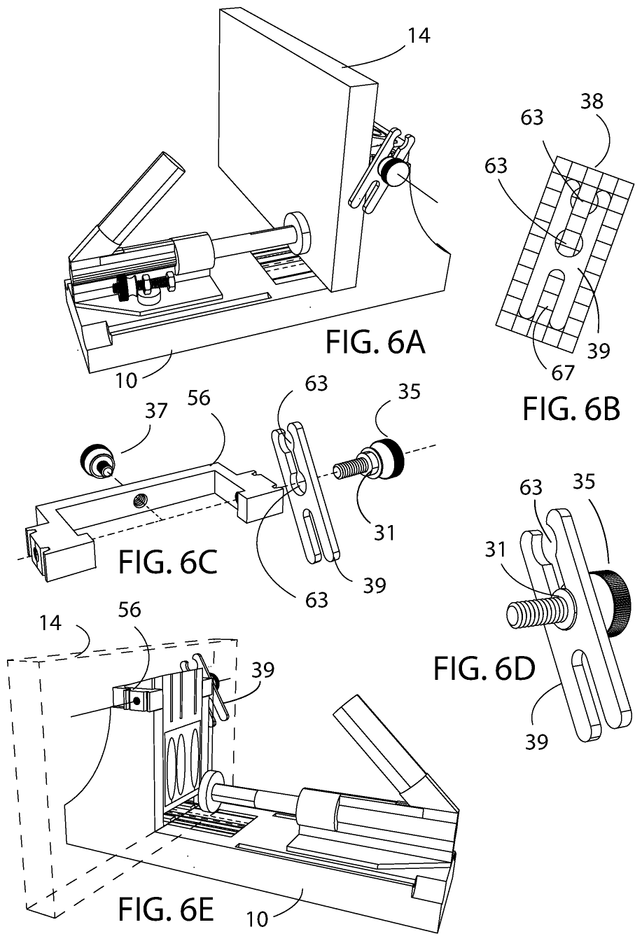

FIG. 6A is a perspective view of a KREG K4 jig 10 shown from the clamp side of the pocket hole jig with an articulating flip stop assembly 39 coupled to the U-shaped fixture 56 on the upright of the jig with a shoulder bolt 35. The shoulder of the bolt 35 is smaller than the opening 63 in the H-shaped flip arm 39 and allows the arm 39 to rotate around the bolt 35. The H-shaped flip arm is configured to hang at an angle and contacts the edge of the panel 14, and thus positions the panel in relationship to the drilling holes. FIG. 6B is a quarter inch grid 38 showing the shape of the example H-shaped flip stop arm 39 with the location of the shoulder portion of the shoulder bolt 35 shown with a solid black circle. The arm 39 hangs at approximately a 30 degree angle from a vertical orientation due to a predefined center of mass and gravity acting on the flip stop arm 39. FIG. 6C is an exploded view of the U-shaped fixture 56 showing the shoulder bolt 35 located in alignment with the central-most opening 63 of the H-shaped flip stop arm 39. FIG. 6D is a perspective view showing the shoulder bolt 35 shoulder 31 located through the central-most opening 63 of the H-shaped flip stop arm 39. FIG. 6E is a perspective view of a KREG K4 jig 10 shown from the opposite side of the view from FIG. 6A. The outside of the panel 14 is illustrated with a dotted line. The shoulder 31 of the bolt 35 is smaller than the opening 63 in the H-shaped flip arm 39 and allows the arm 39 to rotate around the bolt 35. The H-shaped flip arm 39 hangs at an angle and contacts the edge of the panel and thus positions the panel in relationship to the drilling holes. That is, in one example embodiment, the flip arm 39 is configured to have a resting orientation whereat a portion of the flip arm 39 extends beyond the vertical plane of the drill guide 12, thus being able to engage an end of the workpiece 14.

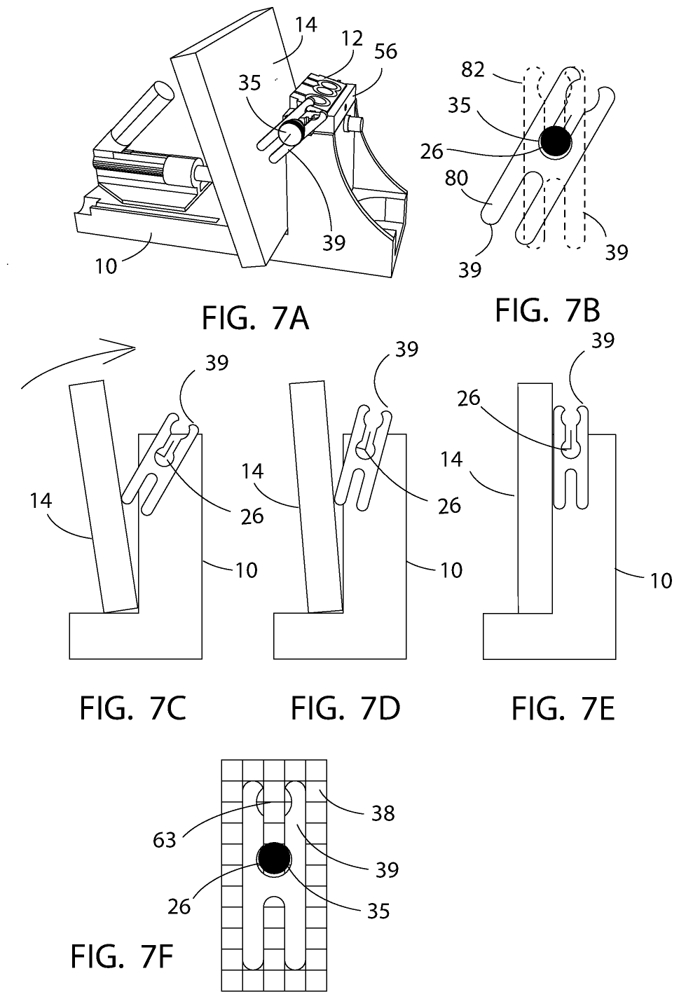

FIG. 7A is a perspective view of a KREG K4 jig 10 showing that the H-shaped flip arm 39 hangs at an angle about pivot point 26. As the panel 14 is moved against the drill guide 12, the hanging flip stop 39 is rotated to a vertical position. FIG. 7B shows two positions of the flip arm 39. The angled solid line H is the resting position. The vertical dotted line is the engaged position. FIG. 7C shows the panel 14 starting to touch the flip stop 39. FIG. 7D shows the panel 14 starting to rotate the flip stop 39. FIG. 7E shows the panel 14 in position for drilling with the flip stop arm 39 rotated to the vertical position. FIG. 7F is a quarter inch grid 38 showing the shape of the example H-shaped flip stop arm 39 with the shoulder of the bolt 35 shown with a solid black circle.

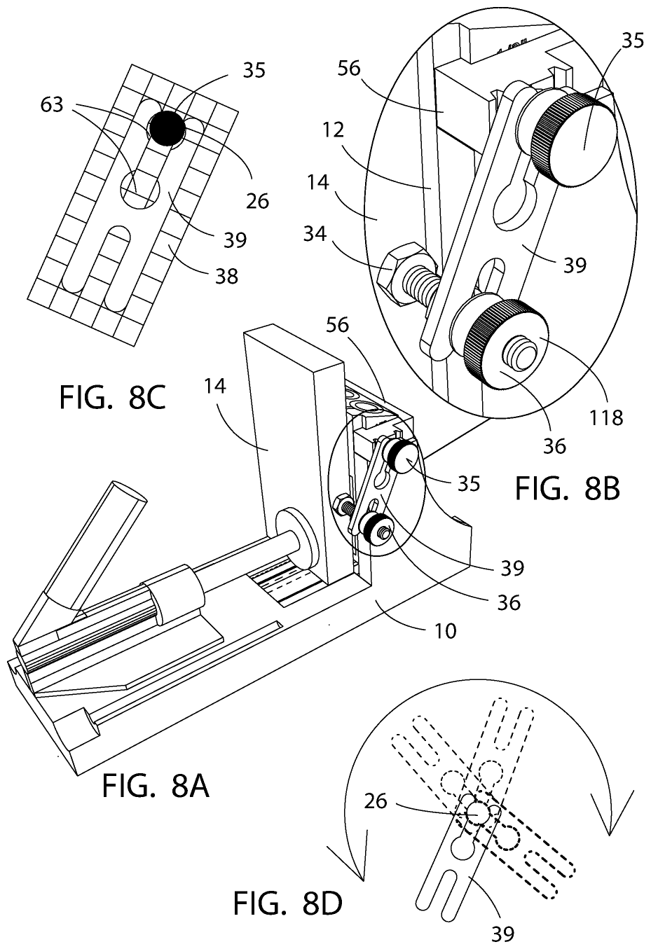

FIG. 8A is a perspective view of a KREG K4 jig 10 shown with the H-shaped flip stop arm assembly 39 attached to the U-shaped fixture 56 with the shoulder bolt 35 fitted into the outer-most opening 63. The adjustable stop bolt 36 is engaged to touch and position the location of the work piece 14 in relationship to the drill guide holes. FIG. 8B is an enlarged view showing the custom made shoulder bolt 35 securing the H-shaped flip stop arm 39 to the U-shaped fixture 56 attached to the drill guide 12. FIG. 8C is a quarter inch grid 38 showing the shape of the H-shaped flip stop arm 39 with the shoulder of the bolt 35 shown with a solid black circle. FIG. 8D is a diagram showing the rotation of the H-shaped flip stop arm 39 about the point of rotation 26. The solid shape illustrates the engaged position.

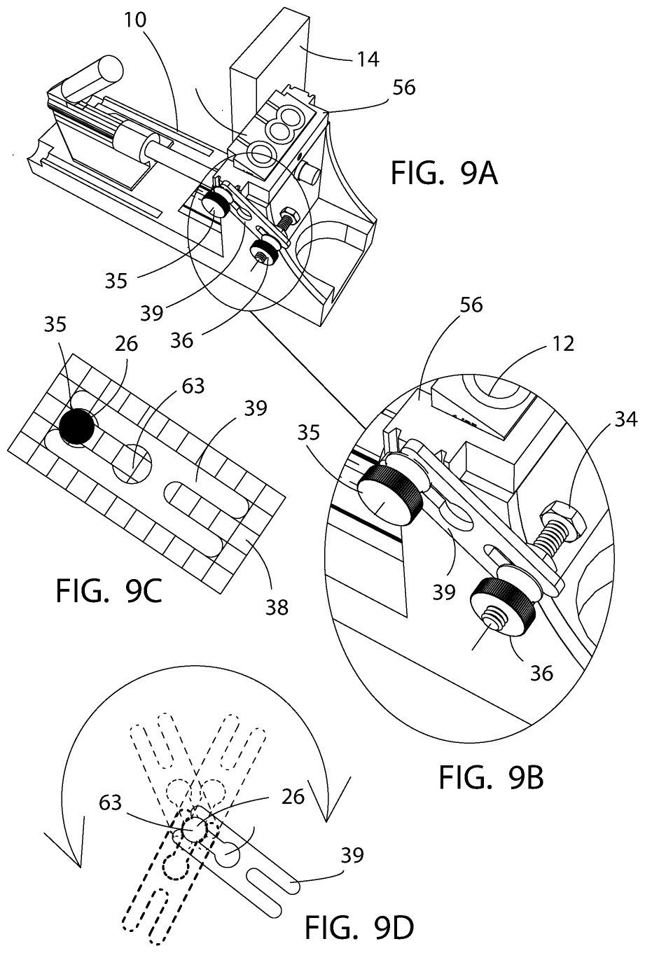

FIG. 9A is a perspective view of a KREG K4 jig 10 shown with the H-shaped flip stop arm assembly 39 attached to the U-shaped fixture 56 with the shoulder bolt 35 fitted into the outside hole 63. The flip stop arm 39 is shown rotated out of the way to the non-engaged position. FIG. 9B is an enlarged view showing a custom made shoulder bolt 35 securing the H-shaped flip stop arm 39 to the U-shaped fixture 56 attached to the drill guide 12. FIG. 9C is a quarter inch grid 38 showing the shape of the H-shaped flip stop arm 39 with the shoulder of the bolt 35 shown with a solid black circle. FIG. 9D is a diagram showing the rotation of the H-shaped flip stop arm 39 about the pivot 26. The solid shape illustrates the non-engaged position.

FIG. 10A is an exploded view of the U-shaped fixture 10 showing the shoulder bolt 35 located through the outer end opening 63 of the H-shaped flip stop arm 39. FIG. 10B is an enlarged view of FIG. 10A showing a custom made shoulder bolt 35 located in the H-shaped flip stop arm 39 in accordance with one embodiment. FIG. 10C is an enlarged view of FIG. 10A showing a custom made shoulder bolt 35.

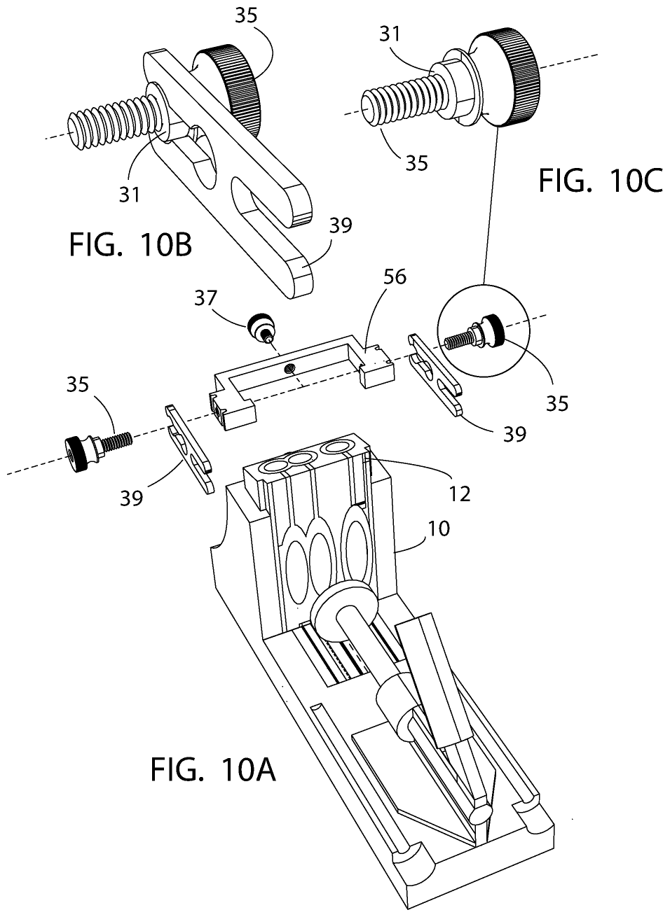

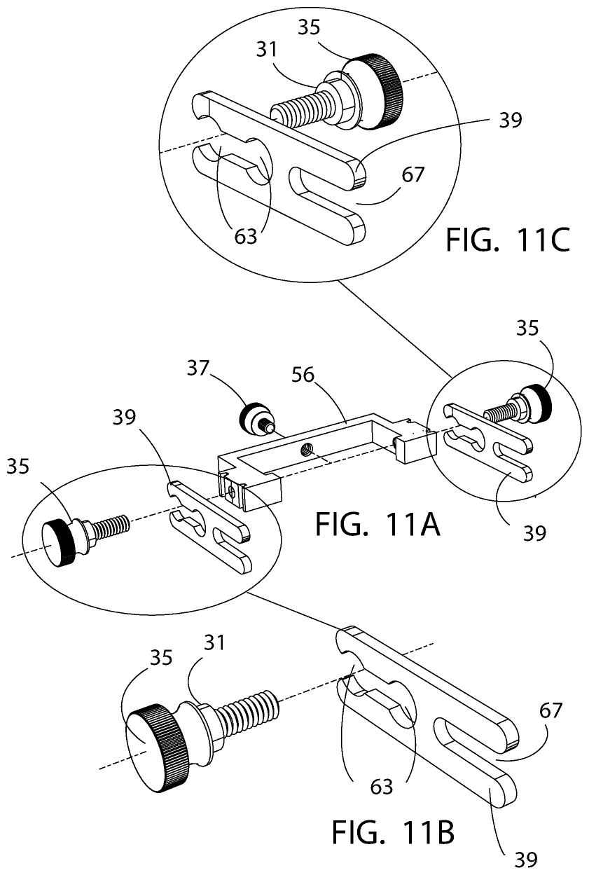

FIG. 11A is an exploded view of the U-shaped fixture 56 showing the shoulder bolt 35 located through the outside opening 63 of the H-shaped flip stop arm 39. FIG. 11B is an enlarged view of FIG. 11A showing a custom made shoulder bolt 35 with shoulder 31 from the knob perspective. FIG. 11C is an enlarged view of FIG. 11A showing a custom made shoulder bolt 35 from the thread perspective.

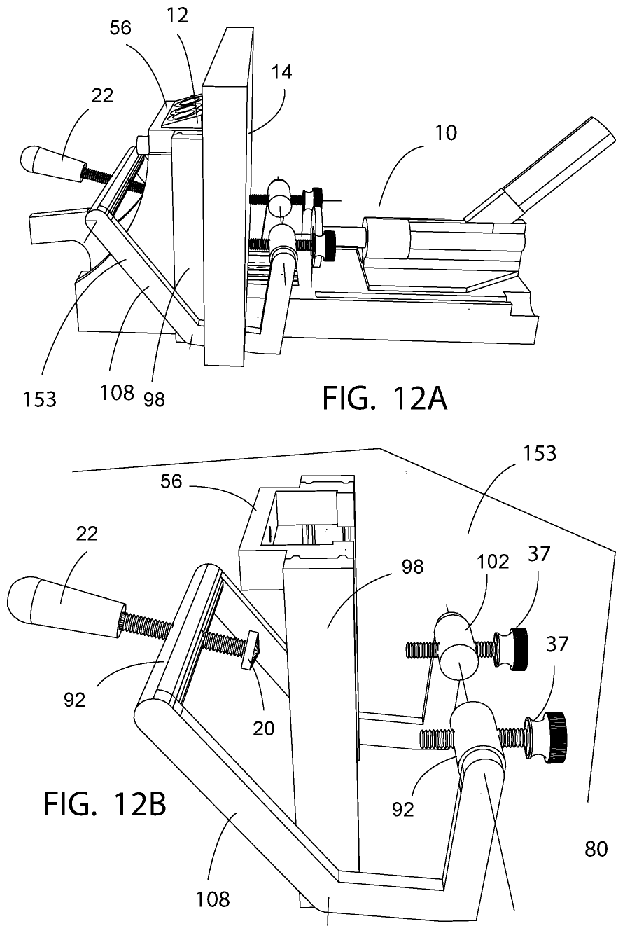

FIG. 12A is a perspective view of a KREG K4 jig 10 shown with the panel clamp 153 attached to an arm 98 located vertically from the U-shaped fixture 56 attached to the drill guide 12 with the panel 14 in place. FIG. 12B is a perspective view of the panel clamp 153, the vertical arm 98, and the U-shaped fixture 56 with the panel 14 removed.

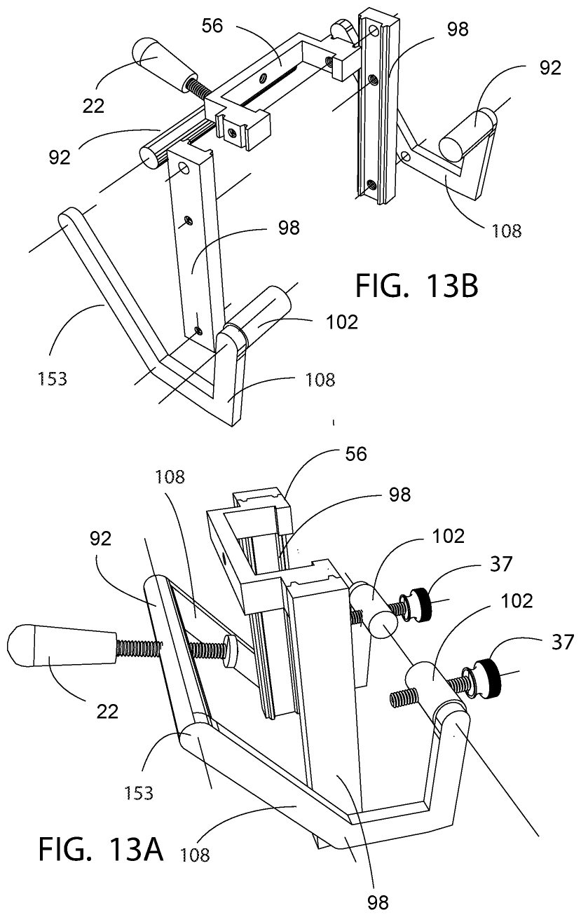

FIG. 13A is perspective view of the clamp-on panel frame 153. The thumb screws 37 clamp the panel to the pocket hole jig 10. The thumb screws 37 are adjusted for the width of the panel. The final clamping is done with the hand screw 22. The U-Shaped frame 56 clamps onto the pocket hole drill guide 10. The vertical extrusion 98 connects to the U-shaped frame 56 which clamps on to pocket hole drill guide 10. FIG. 13B is an exploded view of the parts of the frame clamp 153 illustrated in FIG. 13A.

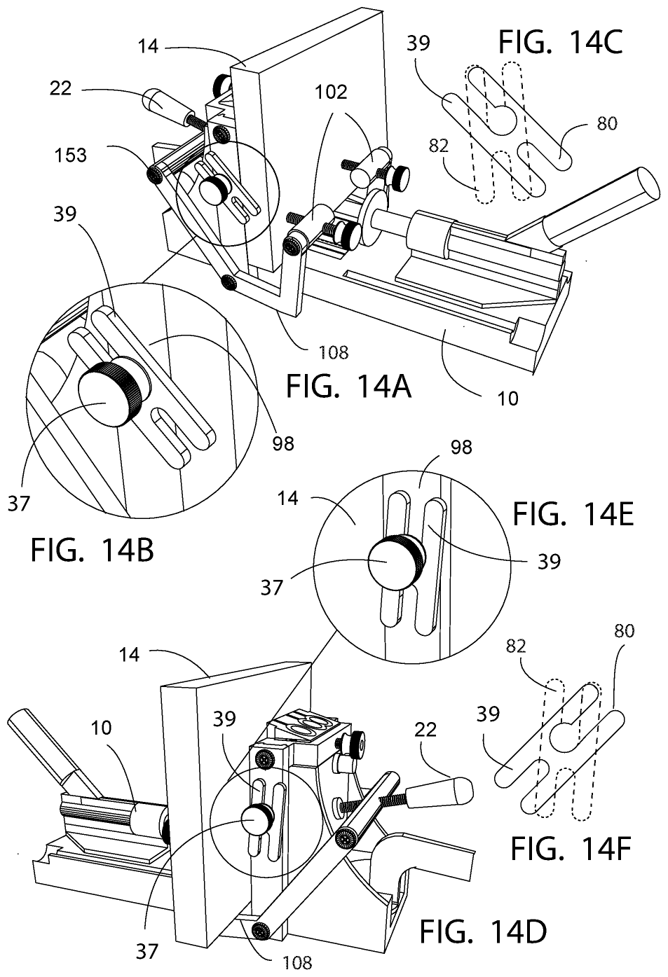

FIG. 14A is a perspective view of a KREG K4 jig 10 shown with the panel clamp 153 attached to an arm 98 located vertically from the U-shaped fixture 56. The clamp-on panel clamp 153 is illustrated with a panel workpiece 14 clamped in place to be drilled with the jig. An H-shaped flip stop arm 39 is illustrated attached the vertical frame member 98 with a thumb screw 37. The illustration shows the H-shaped flip stop arm 39 in contact with the edge of the board 14. Located on the vertical arm 98 is the H-shaped flip stop 39 in the engaged angled position. FIG. 14B is an enlarged view of the flip arm 39 shown in FIG. 14A. FIG. 14C is a diagram showing the resting position of the H shaped arm 39 with the resting position shown with a solid line 80 and the rotated position shown with a dotted line 82. FIG. 14D is a perspective view of a KREG K4 jig 10 shown with the panel clamp 153 attached to an arm 98 located vertically from the U-shaped fixture 56. Located on the vertical arm 98 is the H-shaped flip stop 39 in the non-engaged vertical position. FIG. 14E is an enlarged view of the flip arm 39 shown in FIG. 14C. FIG. 14F is a diagram showing the resting position of the H-shaped arm 39 with the resting position shown with a solid line 80 and the rotated position shown with a dotted line 82.

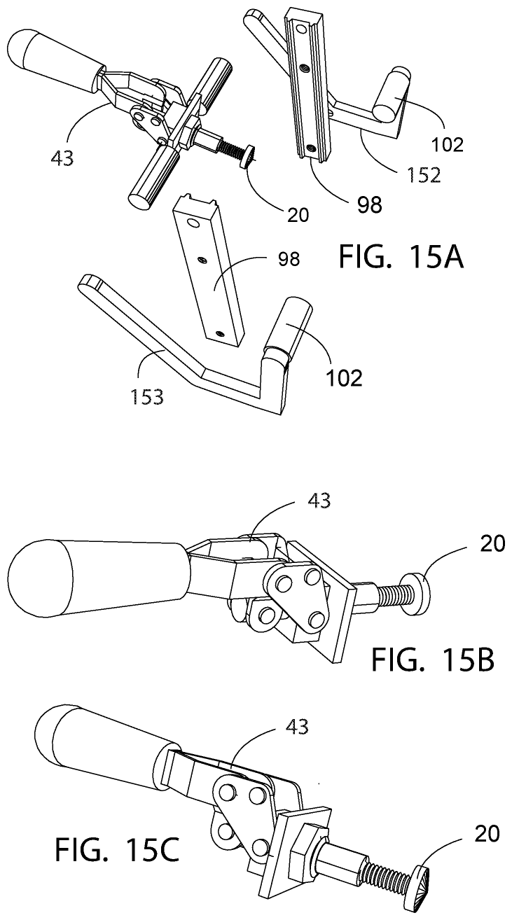

FIG. 15A is an exploded view of an example embodiment of the U-shaped clamp-on fixture 153, the vertical arms 98, and the U-shaped side brackets 108. The drawing is shown with a quick action clamp 43. FIG. 15B illustrates the handle side of the quick action clamp 43. FIG. 15C illustrates the lock nut side of the quick action clamp and the clamp pad 20.

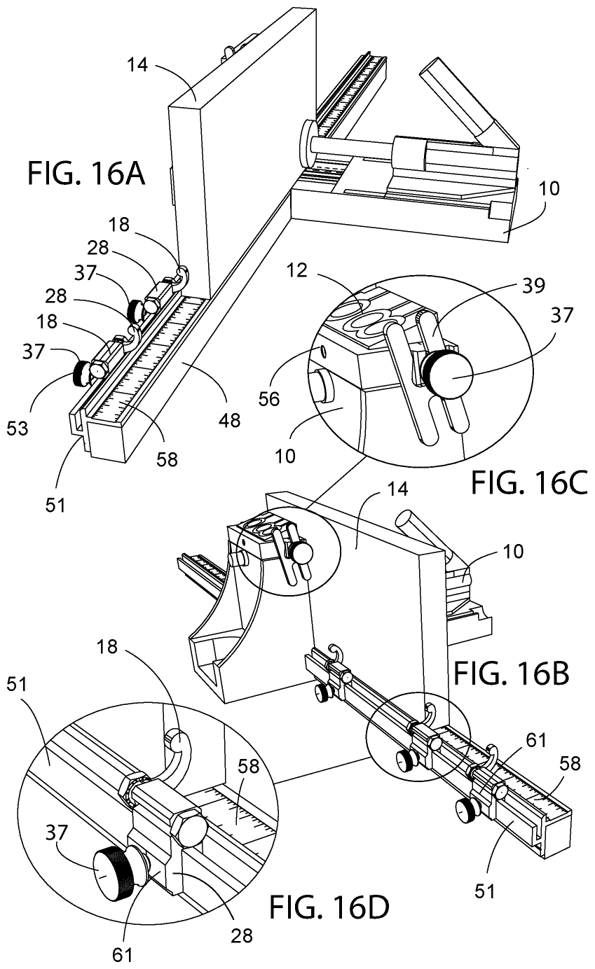

FIG. 16A is a perspective view of a clamp side of the KREG K4 jig 10 shown with support boards 48 extending from each side of the jig 10. On top of the support board 48 is an extrusion 51 with a web that supports a clamp-on flip stop 28. The drawing shows a panel 14 resting on the jig 10 and support board extrusion 48 with the edge of the panel 14 in contact with the flip stop arm 18. FIG. 16B is a perspective view of a drill guide side of the KREG K4 jig 10 shown with support boards 48 extending from each side of the jig 10. On top of the support boards 48 is an extrusion 51 with a web that supports a clamp-on flip stop 28. The drawing shows a panel 14 resting on the jig 10 and support board extrusion 51 with the edge of the panel 14 in contact with the flip stop arm 18. A rotatable H-shaped flip stop arm 39 is attached to the U-shaped fixture 56 surrounding the drill guide 12. The panel 14 has rotated the H-shaped flip arm 39 to the nearly vertical position FIG. 16C is an enlarged view of the flip arm 39 shown in FIG. 16B. FIG. 16D is an enlarged view of the flip stop arm 18 shown locked on the support board extrusion 51 illustrated in FIG. 16B.

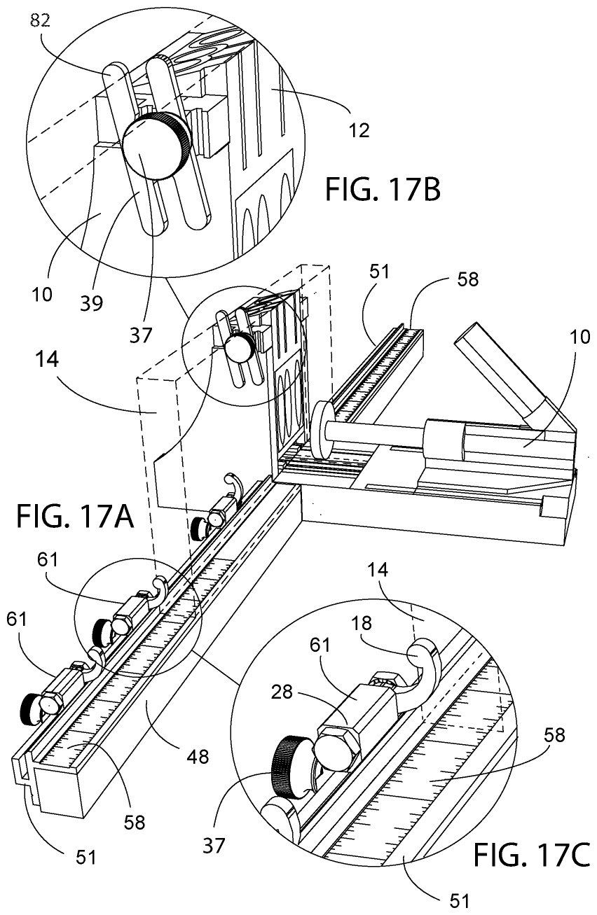

FIG. 17A is a perspective view of a clamp side of the KREG K4 jig 10 shown with support boards 48 extending from each side of the jig 10. On top of the support boards 48 is an extrusion 51 with a web that supports a clamp-on flip stop 61. The drawing shows a panel 14 resting on the jig 10 and support board extrusions 51 with the edge of the panel 14 in contact with the flip stop arm 18. The panel 14 is illustrated with a dotted line. FIG. 17B is an enlarged view of the flip arm 39 shown in FIG. 17A. FIG. 17C is an enlarged view of the flip stop arm 18 shown coupled to the support board extrusion 51 and in contact with the edge of the panel 14 as illustrated in FIG. 16B.

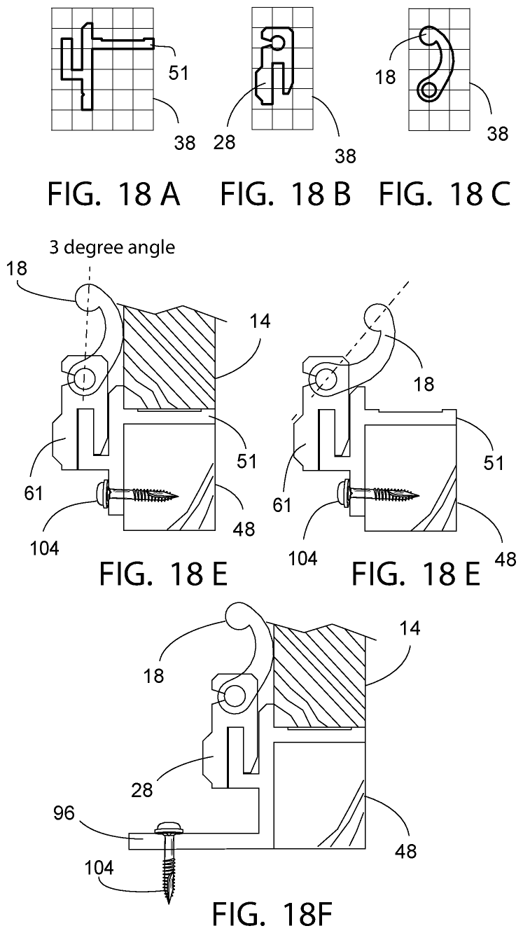

Example embodiments of various components are illustrated in FIGS. 18A-18C. FIG. 18A is an end view of the support board extrusion 51. FIG. 18B is an end view of the flip stop base 28. FIG. 18C is an end view of the flip stop arm 18. Turning to FIGS. 18E-18F, FIG. 18D is an end view of the flip stop arm 18 resting against the workpiece 14. In the example embodiment, the arm 18 may be rotated at a 3 degree angle from vertical when it is in contact with the workpiece 14. FIG. 18E is an end view of the support board extrusion 51, and the flip stop base 28 and arm 18 of the clamp-on flip stop 61. Gravity urges the flip stop arm 18 into position with the bottom of the flip stop arm 18 resting on a protrusion on top of the L-shaped support board extrusion 51. In the resting position, the flip arm 18 of the example embodiment is angled at 40 degrees. FIG. 18F is an end view of another example embodiment of a support board extrusion 51 and flip stop base 28 and arm 18. The bottom of the support extrusion 51 is extended and material is added at 90 degrees parallel to the table top or auxiliary board 48. The bottom has a groove that helps locate the position of a screw hole for attaching the extrusion 51 to a table or auxiliary board, such as with use of fasteners 104 through a mounting flange 96.

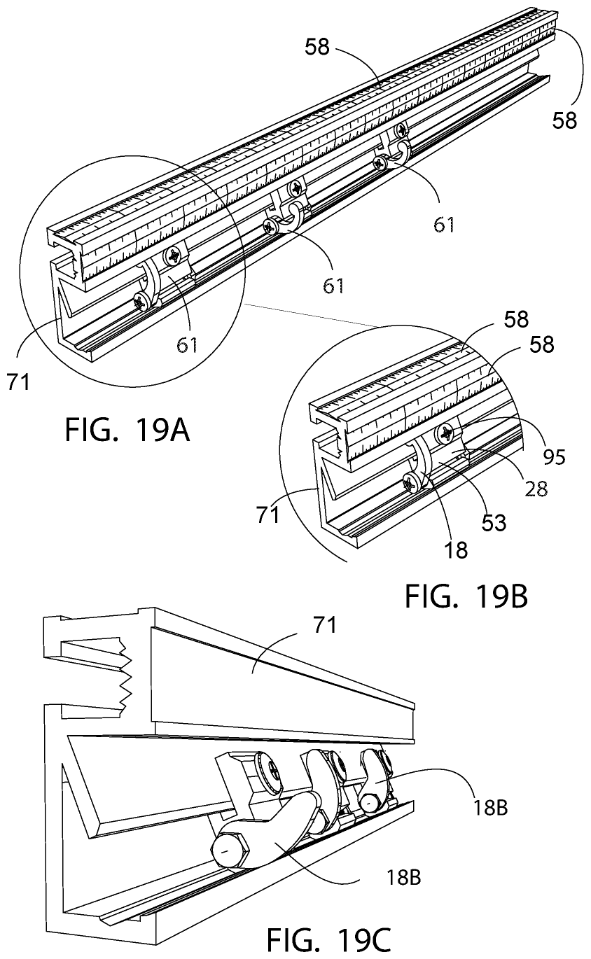

FIG. 19A is a perspective view of a rectangular extrusion 71 that has an angled web that captures the flip arm base 28. FIG. 19B is an enlarged view of the flip arm 18 shown in FIG. 19A. FIG. 19C is an enlarged view of the flip arm shown in FIG. 19B depicting an enlarged alternative flip arm 18B bolted to a base and shown in the resting and engaged positions.

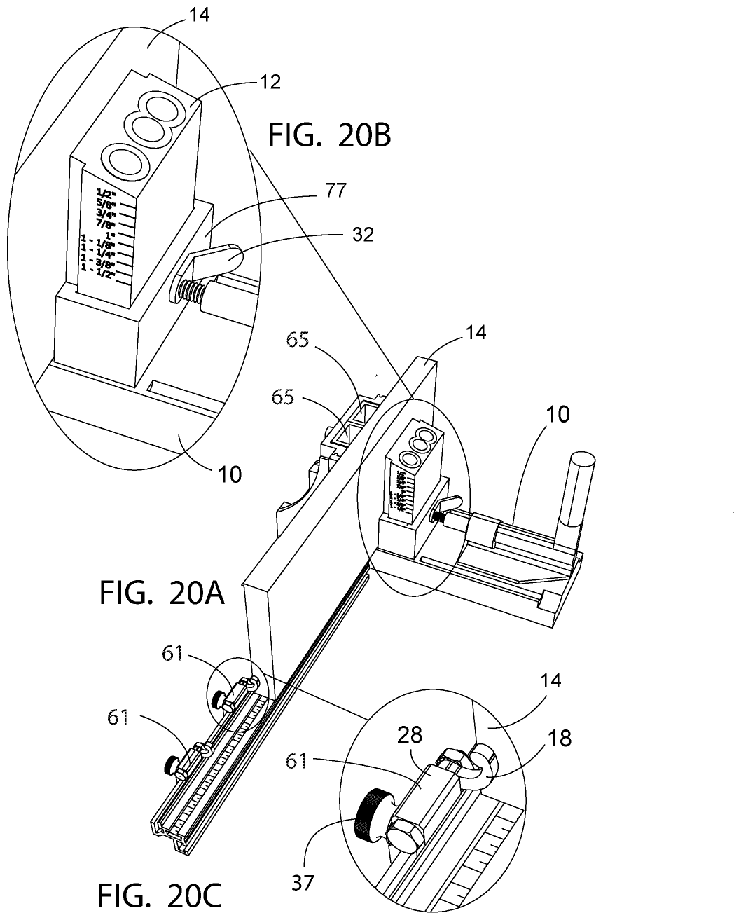

FIG. 20A is a perspective view of a clamp side of the KREG K4 jig 10 shown with a support board extending from at least one side of the jig 10. On top of the support board is an extrusion with a web that supports a clamp-on flip stop 61. The drawing shows a panel 14 resting on the jig 10 and support board extrusion with the edge of the panel 14 in contact with the flip stop arm 18. The illustration shows the drill guide 12 removed from its pocket and rotated 180 degrees and held in place with an example U-shaped extrusion 77. FIG. 20B is an enlarged view of the drill guide 12 and the U-shaped extrusion 77. FIG. 20C is an enlarged view of the flip arm 18 and other components of the flips stop 61 shown in FIG. 20A.

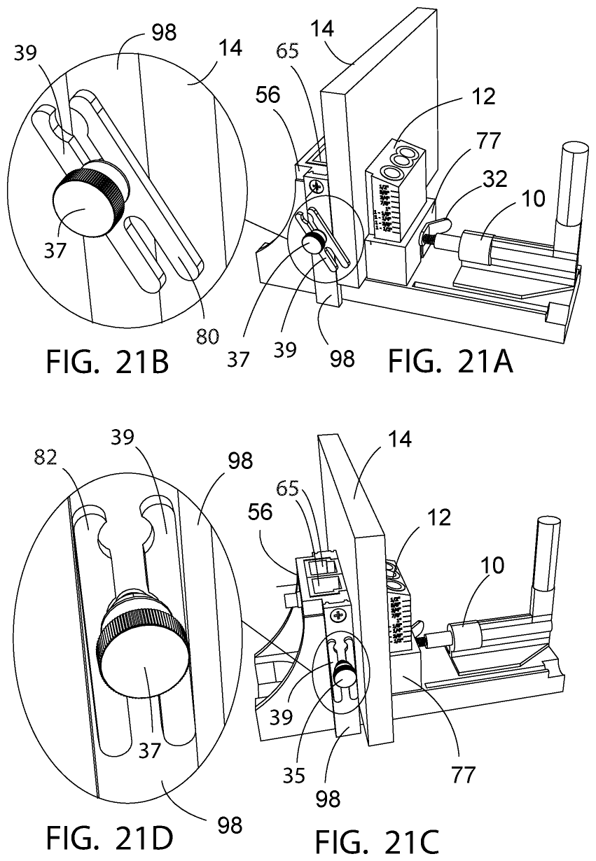

FIG. 21A is a perspective view of the clamp side of the KREG K4 jig 10 shown with a vertical leg 98 secured to the U-shaped fixture 56 surrounding the drill guide 12. A threaded hole in the middle of the vertical leg 98 captures the H-shaped flip arm 39 with a custom made shoulder bolt 35 fitted into the inside or most-central opening 63 of the H-frame. The H-flip arm 39 is in the engaged position with its body touching the edge of the panel 14. FIG. 21B is an enlarged view of the flip arm 39 shown in FIG. 21A. FIG. 21C is a perspective view of the clamp side of the KREG K4 jig 10 shown with a vertical leg 98 secured to the U-shaped fixture 56 surrounding the drill guide 12. Again, a threaded hole in the middle of the vertical leg 98 may capture the H-shaped flip arm 39 with a custom made shoulder bolt 35 fitted into the inside hole 63 of the H-frame. The H-flip arm 39 is in the disengaged position with body touching the side of the panel. FIG. 21D is an enlarged view of the flip arm 39 shown in FIG. 21A.

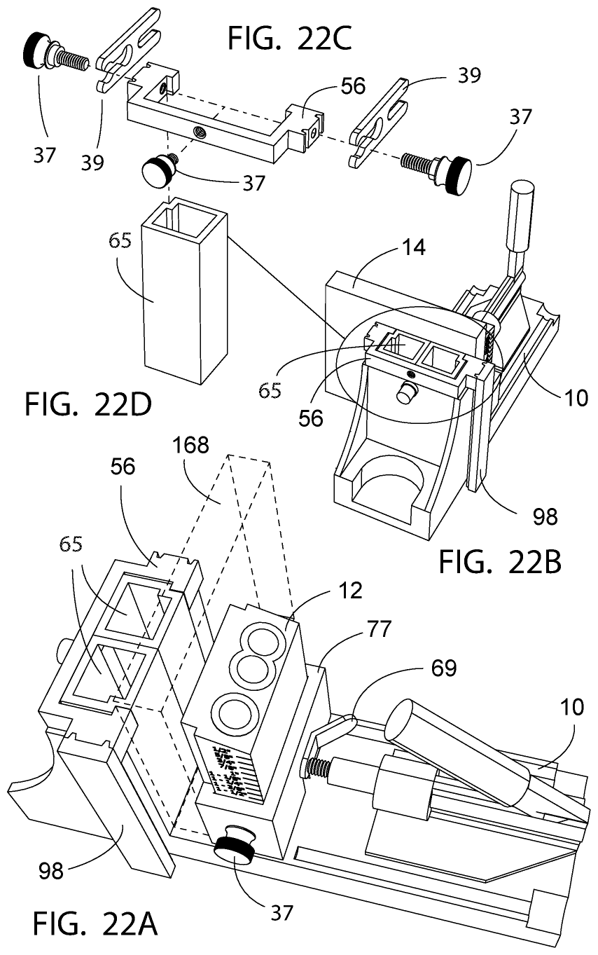

FIG. 22A illustrates a perspective view of the clamp side of the KREG K4 jig 10 shown with a U-shaped fixture 56 surrounding the reversed drill guide 12. The panel 168 clamped in the jig 10 is illustrated with dotted lines. The space usually occupied by the drill guide is filled with two generally identical rectangular extrusions 56 that have an indentation in one corner matching the indentation in the corner of the drill guide. The reverse drill guide is held in a U-shaped fixture 77. A thumb screw 37 on the side of the U-shaped fixture 77 secures the drill guide 12. One advantage of this arrangement is that the clamp and the drill guide are on the same side so that the operator does not have to reach around the workpiece (e.g., panel 168) to engage and release the clamp for each new drilling series. FIG. 22B is a perspective view of the KREG K4 jig 10 shown from opposite the clamp side. The space usually occupied by the drill guide is filled with two identical rectangular extrusions 65 that have an indentation in one corner matching the indentation in the corner of the drill guide 12. FIG. 22C is an explode view of FIG. 22B illustrating the use of the cavity spacers 65. The cavity spacers 65 may comprise shop made pieces of wood, plastic extrusions, and the like. FIG. 22D is a perspective view of one of the two spacers 65 that are occupying the usual space of the drill guide. KREG offers a K5 model that has similar side clamp and drilling, but is larger and more expensive than the K4 shown in these illustrations. The same side clamping fixture 77 allows same side clamping without the need to buy an expensive jig.

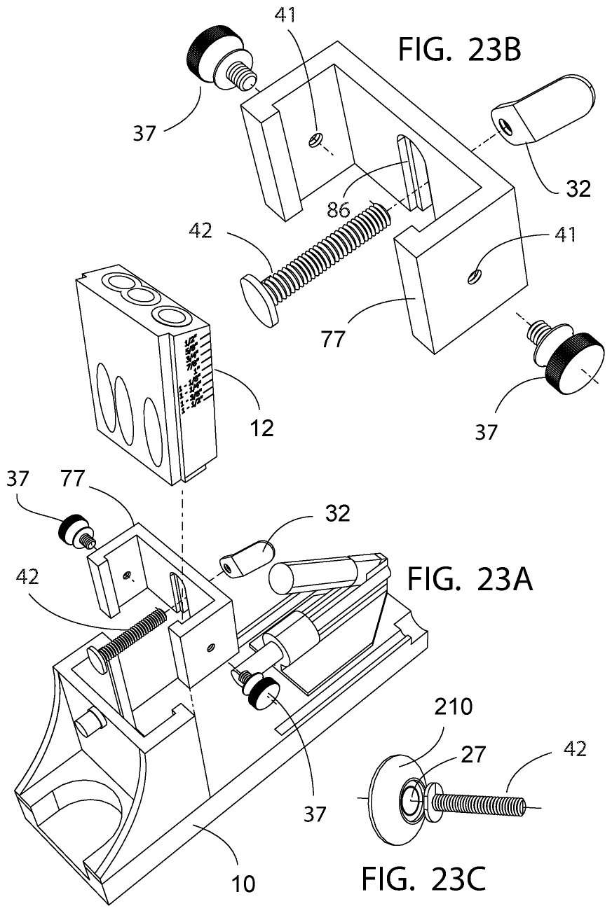

FIG. 23A is an exploded view of the example U-shaped clamp-on fixture 77 that secures the drill guide 12 to the clamp plunger. A machined opening 86 provides a space for the head of a toilet bolt 42 that is secured with a curved flat nut 32. FIG. 23B is an exploded view of the U-shaped clamp-on fixture 77 that secures the drill guide to the clamp plunger. A slotted groove 86 captures the head of a toilet bolt 42 that replaces the clamp pad. FIG. 23C includes a clamp pad 210 with a magnet 27 that releasably secures the pad 210 to the head of the toilet bolt. In one embodiment, the round clamp pad may include a round cavity that accepts a round rare earth magnet and another larger round cavity that accepts the oblong head of the toilet bolt as it is attached to the magnet.

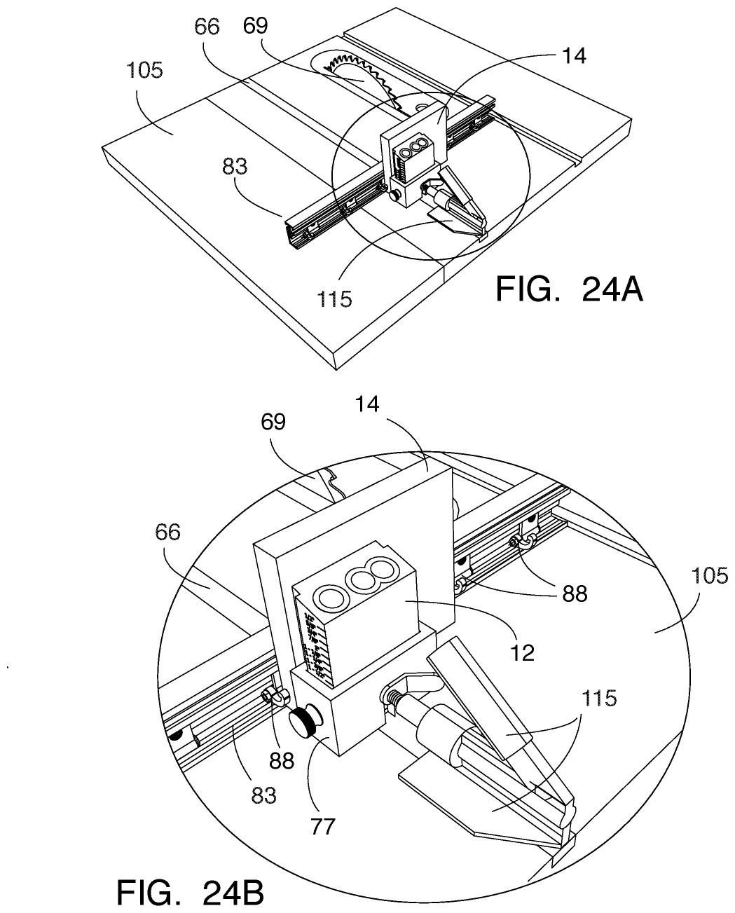

FIGS. 24A and 24B illustrate a table saw 105 (with a saw blade 69) shown with a U-shaped fixture 77 surrounding the reversed drill guide 12 that is attached to the Des-ta-co style quick action clamp 115, which is secure to a miter bar 66. The panel 14 is sandwiched between the drill guide 12 and the rectangular extrusion 83. FIG. 24B is an enlarged view of the U-shaped clamp-on fixture 77 that secures the drill guide 12 to the clamp plunger. There are a number of advantages of having the drill on the table of a saw or router table, such as not requiring side supports. Small micro flip stops 88 are located inside the miter fence extrusion 83 to measure the location of the panel 14. The U-shaped fixture 77 is less expensive than a free standing pocket hole jig.

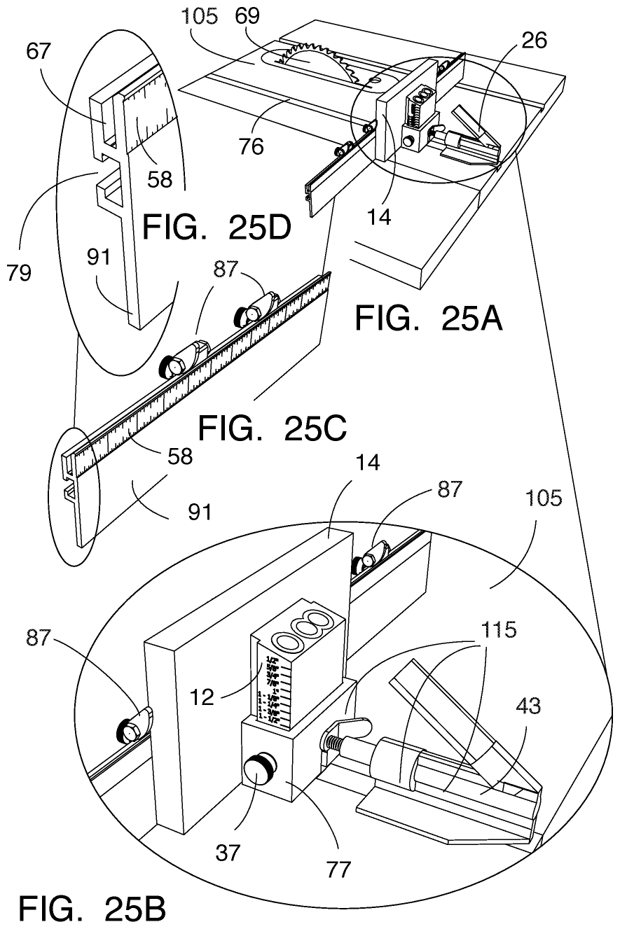

FIGS. 25A-D illustrate a table saw 105 shown with a U-shaped fixture 77 surrounding the reversed drill guide 12 that is attached to the Des-ta-co style quick action clamp 115. The panel 14 is sandwiched between the drill guide 12 and an example custom extrusion 91 that has a leg 67 supporting the clamp-on flip stop 87. The extrusion has a T-slot 79 in the back for connecting it to the saw miter gauge head shown in FIG. 25C. The illustration shows a clamp on flip stop 87. Throughout the description, the various example extrusion profiles described can be adapted to accommodate application-specific requirements and/or needs.

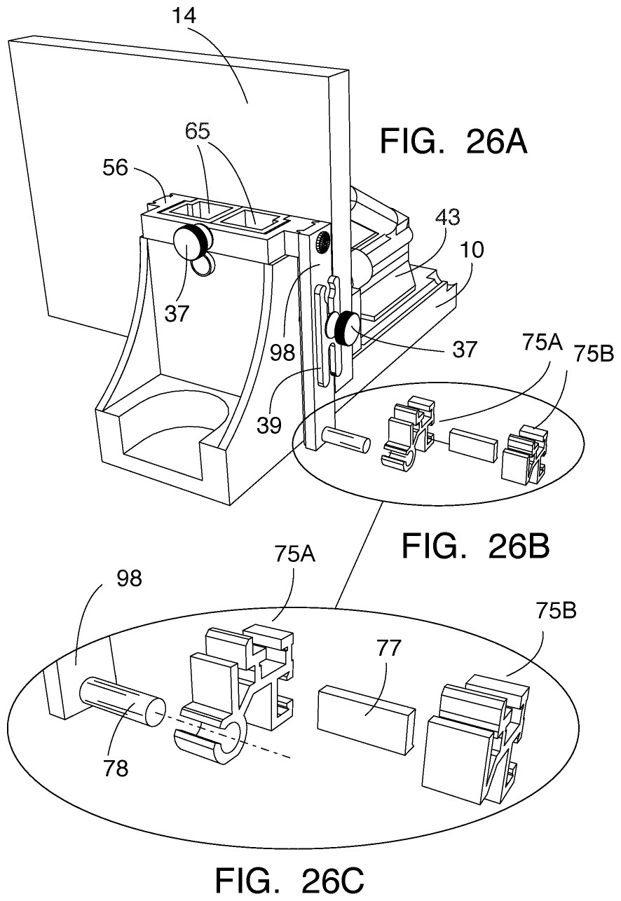

FIG. 26A is a perspective view of the KREG K4 jig 10 shown with a vertical leg 98 secured to the U-shaped fixture 56 surrounding the drill guide. A round dowel 78 is secured to the bottom of the vertical leg 98. An extrusion 75A with a round opening fits over the dowel 78. Another extrusion 75B with a similar design, except for the round opening, is secured with a rectangular extrusion 77 fitted in a T-slot in both extrusions. FIGS. 26B and 26C are enlarged views of the extrusions 75A, 75B, 77 shown in FIG. 26A.

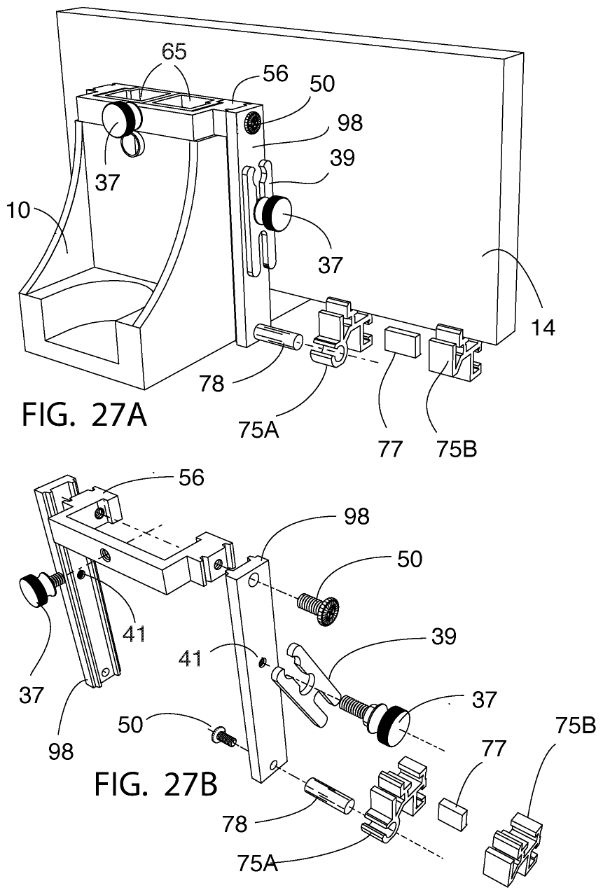

FIG. 27A is an exploded view of the example extrusions 75A, 75B, 77 shown in FIG. 26B supporting a panel 14. FIG. 27B is an exploded view of the U-shaped fixture 56, the vertical leg 98, the flip arm 39, and the extrusions 75A, 75B, 77 for supporting a panel 14.

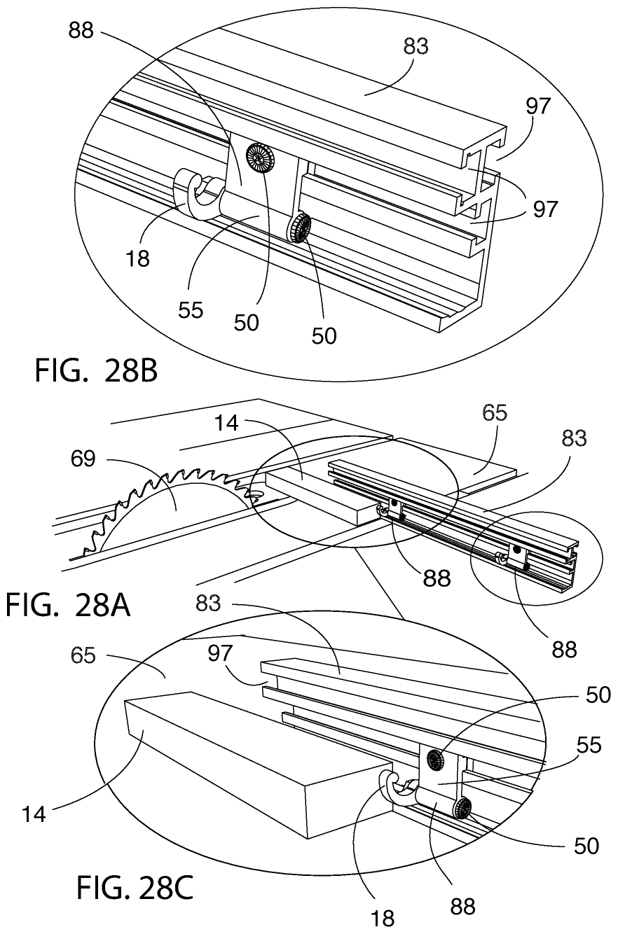

FIG. 28A is a perspective view of a table saw fitted with a rectangular extrusion 83 with an example micro flip stop 88 locked or secured to a T-slot 97. The flip stop 88 is in the engaged position in contact with the end of the workpiece board 14. FIG. 28B is an enlarged view of the extrusion 83 shown in FIG. 28A illustrating the design of the extrusion that is rectangular in shape with two T-slots 97 on opposite sides. The bottom T-slot 97 is located inside the extrusion 83 against the back wall. FIG. 28C is an enlarged view of the flip stop 88 shown in FIG. 28A with the flip arm 18 contacting the end of the board 14. The flip stop arm 18 is curved with one end that is configured to weigh enough (and have an appropriate form factor) so that its resting position is laying outside of the track extrusion 83.

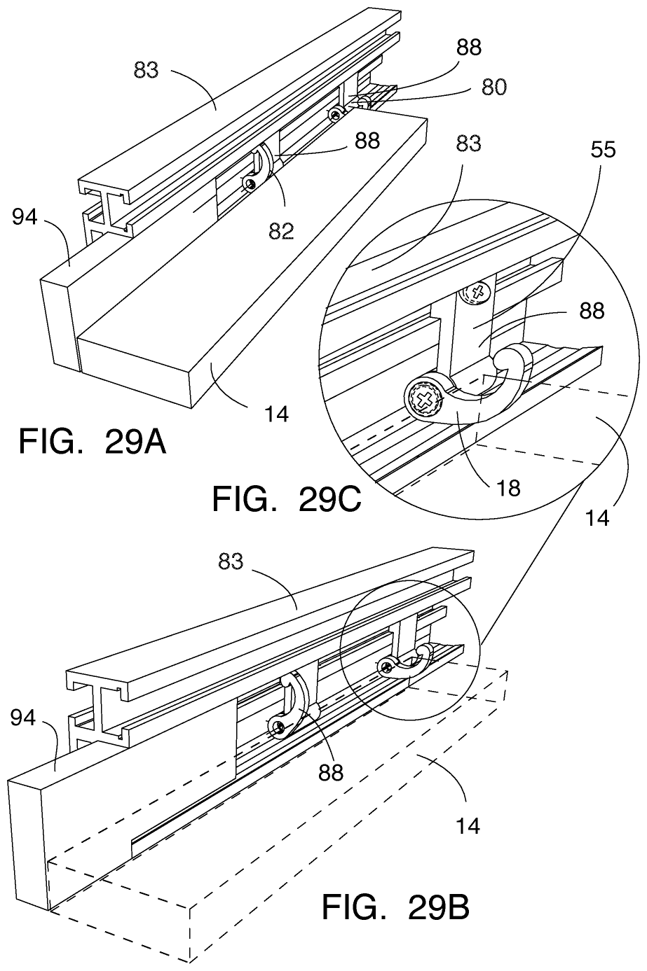

FIG. 29A is a perspective view of a rectangular extrusion 83 with a micro flip stop 88 secured to a T-slot. The flip stop 88 in the front of the illustration is in the disengaged position, and the flip stop 88 at the back of the illustration is in the engaged position with the flip stop arm 18 in contact with the end of the workpiece 14. A “zero” clearance fence 94 is attached to the extrusion 83. FIGS. 29B and 29C are rotated enlargements of FIG. 29A with the work piece board 14 illustrated with dotted lines.

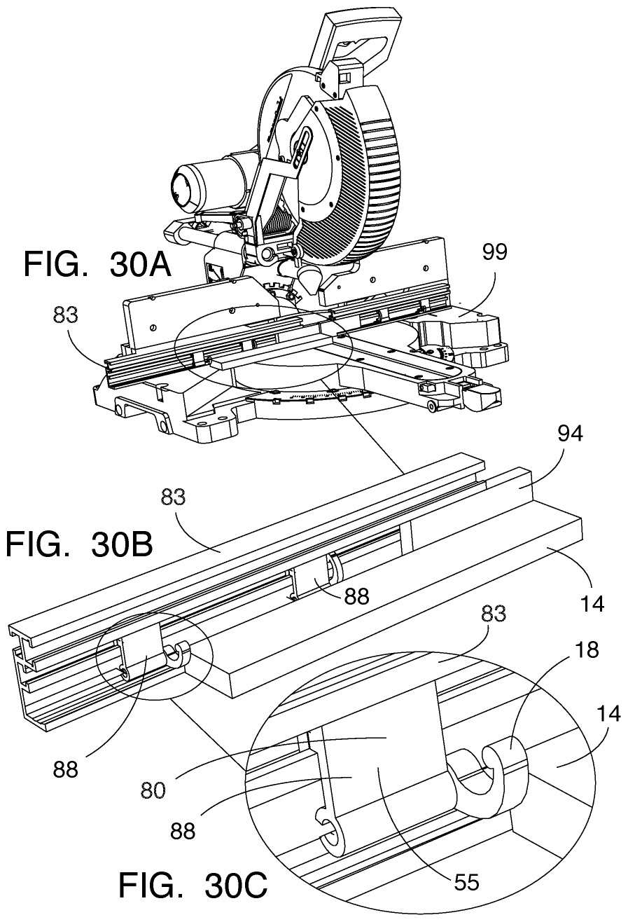

FIGS. 30A-30C illustrate the use of the rectangular extrusion 83 with an example micro flip stop 88 locked to a T-slot 97 as an accessory for a miter saw 99. FIGS. 30A and 30B are similar to the set-up as FIG. 27 illustrated on a miter saw, with FIG. 30C being an enlargement of the flip stop 88 shown in FIG. 30B.

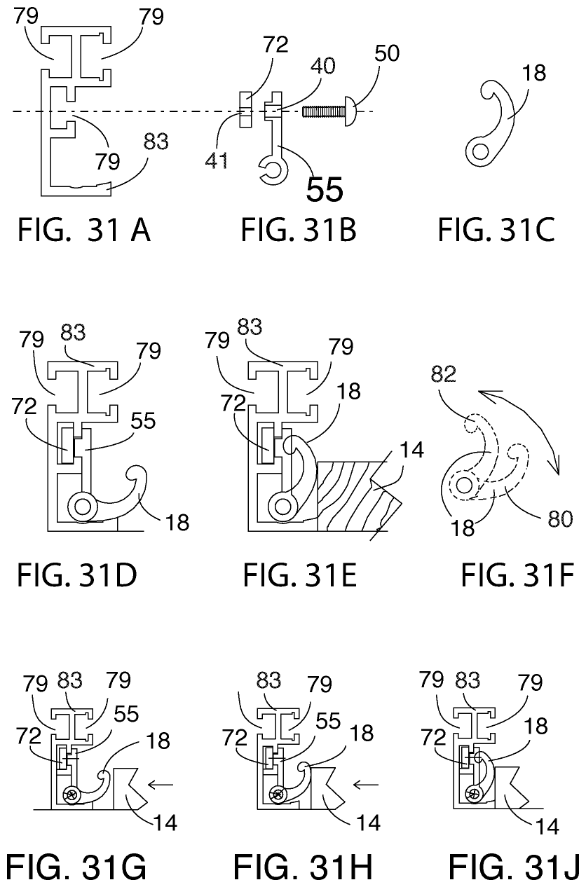

FIG. 31A is the end view of the rectangular extrusion 83 with an interior T-slot 79. FIG. 31B illustrates the end view of the flip stop base extrusion 55 having a through hole 40, a rectangular extrusion 72 with a threaded hole 41, and a fastener 50 used to secure the components. FIG. 31C is the end view of an example curved micro stop arm 18. FIG. 31D is a view of the micro stop arm 18 in the open position oriented with gravity urging the micro stop arm 18 outside the body of the rectangular extrusion 83. FIG. 31E shows the stop arm 18 in the closed position being urged into the body of the extrusion 83 by the workpiece board 14. FIG. 31F is an end view of the stop arm 18 showing the arcuate movement of the stop arm 18 between both the engaged and disengaged positions, with the flip stop arm illustrated with dotted lines. FIG. 31G is the end view of the stop arm 18 showing the flip stop arm 18 resting outside the body of the extrusion 83 prior to engagement with the workpiece 14. In FIG. 31H, an end view of the stop arm 18 shows the workpiece 14 engaging with the flip arm 18 and starting to rotate the flip arm 18 toward and into the body of the rectangular extrusion 83. In FIG. 31J, the flip stop arm 18 is shown with the workpiece 14 against the extrusion 83 with flip arm 18 moved into the body of the rectangular extrusion 83. The curved shape of the example flip stop arm 18 allows it to move very smoothly against a workpiece 14.

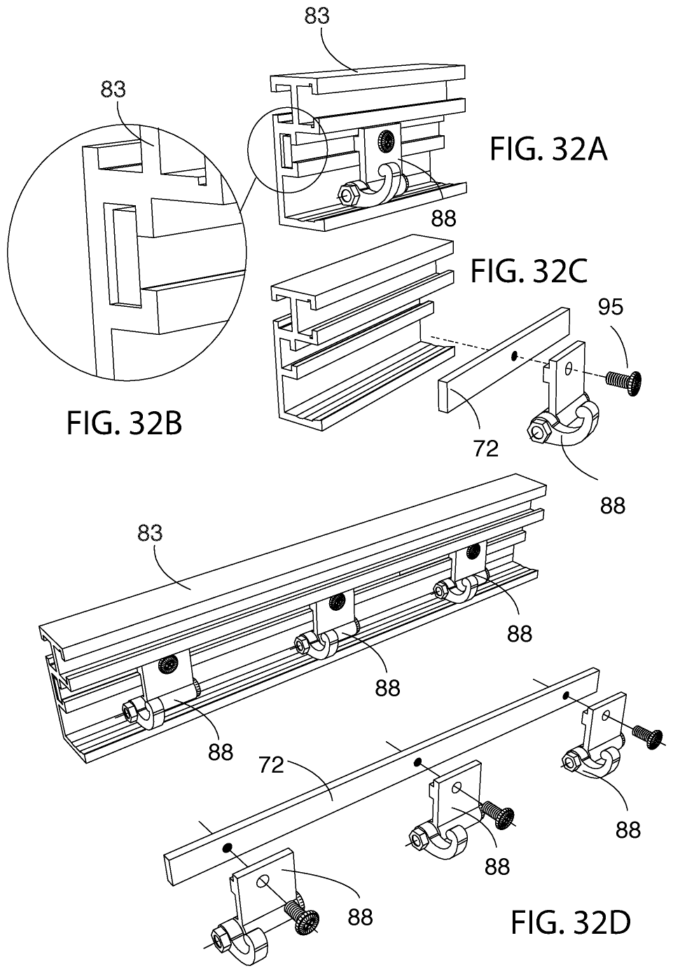

FIGS. 32A and 32B illustrate a perspective view of a rectangular extrusion 83 with a micro flip stop 88 locked (e.g., captured in at least one direction) to a T-slot inside a rectangular extrusion 83. The micro flip stop 88 is shown in the open position with gravity urging the flip arm 88 to a position where it is rotated to extend partially outside of the envelope of the extrusion 83. FIG. 32C is an exploded view of FIG. 32A illustrating the generally solid rectangular extrusion 72 that, when assembled, is positioned inside the T-slot of the rectangular extrusion 83. FIG. 32D is an assembled and exploded view of the rectangular extrusion 83 with multiple micro flip stops 88 captured to a T-slot. The flip stops 88 are illustrated in the engaged position with gravity pivoting the flip arm 18 to rest at least partially outside the extrusion 83 perimeter envelope. In some examples, a nut that can fit into the T-slot of the extrusion 83 is replaced with the rectangular shaped extrusion 72 that is drilled and tapped to for threads that accept the screws 95, which lock or secure the flip stop base 55 to the extrusion 72. In one embodiment, the tapped extrusion 72 can include a series of holes at 3 inch increments for cutting cabinet rail at 3 inch length options. As one benefit, woodworkers can drill and tap custom holes for bespoke set-up gang stops. As one skilled in the art will appreciate, when given the benefit of this disclosure, the multiple stop setups may be readily changed for various set-up task.

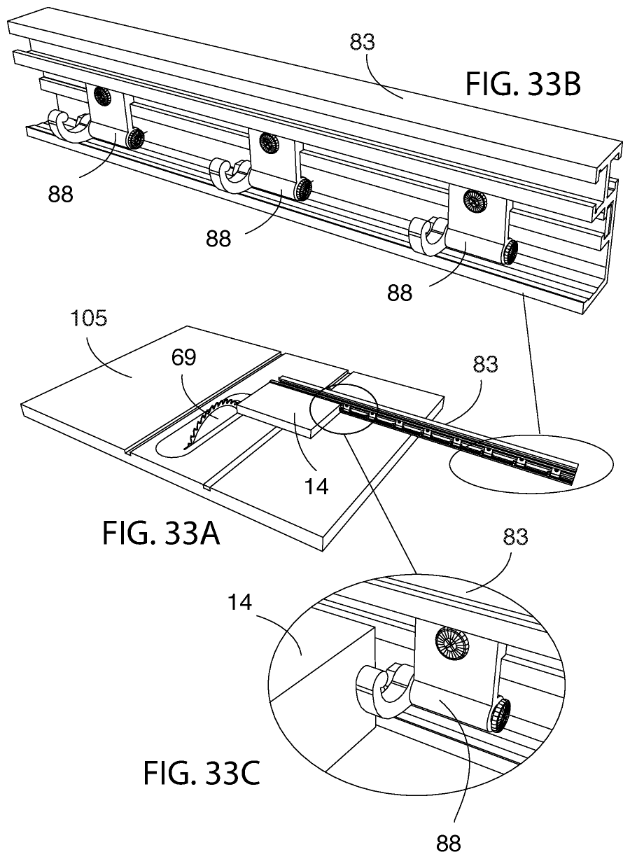

FIG. 33A is a perspective view of a table saw 105 shown with multiple flip stops 88 secured to a threaded extrusion, similar to that shown in FIGS. 32A and 32B. FIG. 33B is an enlarged view of the rectangular extrusion 83 with multiple flip stop 88 locked or captured to a T-slot as shown in FIG. 33A. The flip stops 88 are again illustrated as being in the engaged position with gravity moving the flip arm 18 to rest outside the bounds of the extrusion 83 (i.e., an imaginary vertical plane against which the workpiece 14 is configured to abut in use). FIG. 33C is an enlarged view of the flip stop 88 coupled to a T-slot as shown in FIG. 33A illustrating the curved flip stop arm 18 in contact with the workpiece 14.

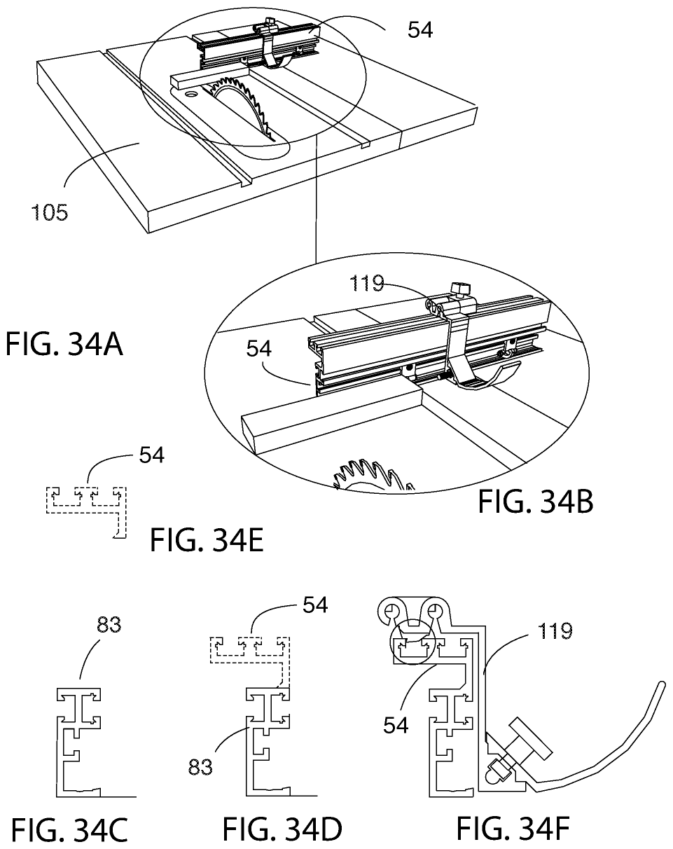

FIGS. 34A and 34B illustrate perspective views of a table saw 105 shown with multiple example, simplified flip stops 88 secured to a threaded extrusion as shown in FIGS. 32A and 32B. The track shown is an L-shaped extrusion with a curved flip stop 119 attached to the top of the track. In FIG. 34C, an end view of the extrusion 83 is shown. And, in FIG. 34D the extrusion 83 is illustrated with the addition of double T-slots 54, as shown with the dotted lines. FIG. 34E is an extrusion end view of the double T-slot that is added to FIG. 34D to creates an L-shaped extrusion 54. FIG. 34F is an end view of the L-shaped extrusion and the curved flip stop extrusions.

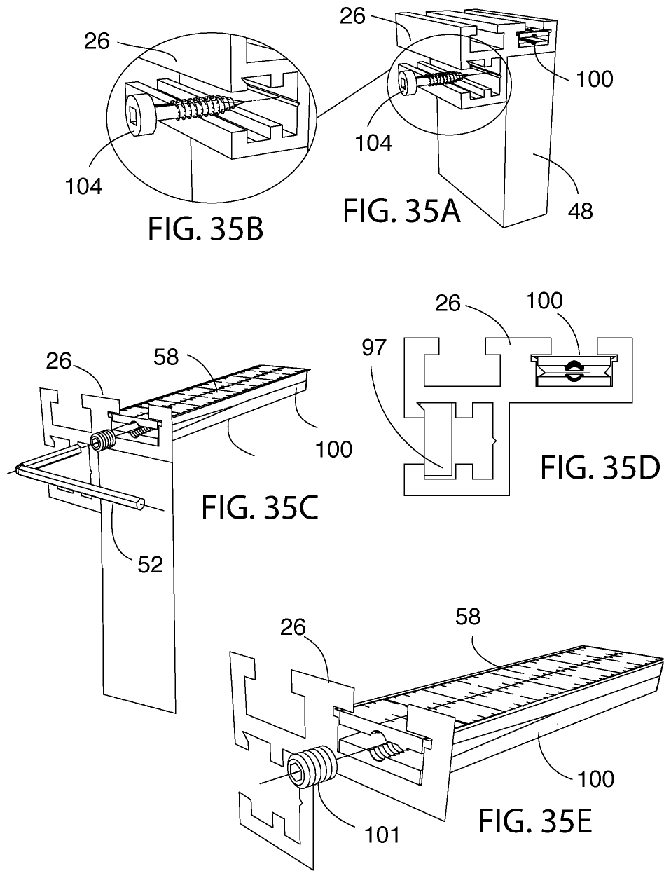

FIG. 35A illustrates a perspective view of an example L-shaped extrusion 26 with two T-slots on a top of the extrusion and one double T-slot on the side. Inside one of the T-slots is a device for securing a measurement device, such as a ruler 58 on a clamp 100, in place. FIG. 35B is an enlargement of FIG. 35A showing a V-groove on the side T-slot that locates the position of a pocket hole screw 104 screw hole for attaching the extrusion to an auxiliary fence, such as with a screw. FIG. 35C is a partial perspective end view of the L-shaped extrusion 26 showing an expandable rectangular inside clamp 100 (supporting the ruler 58) that fits in the T-slot and is expandable with a set screw 101 engaged by an Allen wrench 52 (or similar device). Expanding the clamp 100 secures the position of the movable ruler 58 along the L-shaped extrusion 26. FIG. 35D is an end view of the L-shaped extrusion 26 showing the expandable clamp 100 and the ruler 58, which fits into a groove on each corner of the T-slot. FIG. 35E is an enlargement of FIG. 35C illustrating the clamp 100, the ruler 58, and the engagement with the set screw 101.

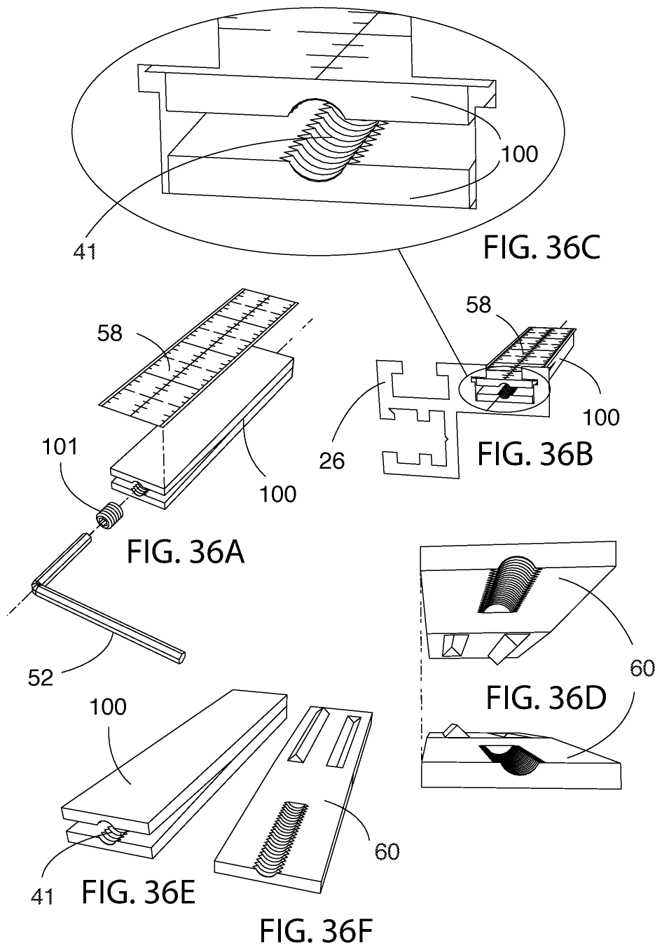

FIGS. 36A-36F depict aspects of the inside clamp 100, the ruler 58, the set screw 101, and the Allen wrench 52 for expanding and thus tightening (e.g., wedging within the slot) the clamp 100. In one embodiment, the clamp 100 has two similar rectangular halves or parts 60 that are sandwiched together to make generally rectangular shape with a tapered, threaded slot 41 along one half. The aligned threaded slots 41 combine to accept and receive the set screw 101. As the set screw 101 is threaded into the resulting hole, the two tapered halves expand to apply clamping pressure on the clamp 100 fitted into the slot on the top of the T-slot extrusion opening. FIG. 36B is an end view of the extrusion 26, the clamp 100, and the ruler 58 showing how the clamp 100 fits into the T-slot of one of the track extrusions 26. FIG. 36C is an enlargement of FIG. 36B illustrating the threads 41 inside the ruler clamp 100. FIG. 36D illustrates that the spreading clamp 100 is made from a sandwich of two similar injection molded plastic parts 60. In one embodiment, the parts 60 may also include alignment and engagement features (e.g., the illustrated recesses and protrusions, such as a positive V-elevation and a negative V-cavity that fit together when the two identical pieces are mated) to help align and mate the two parts 60. FIG. 36E illustrates that the spreading clamp 100 can be made from a sandwich of two generally identical injection molded plastic parts 60 with the threaded hole slots 41 at a slight incline or skew. FIG. 36F illustrates that the spreading clamp is made from a sandwich of two identical injection molded plastic parts with the threaded hole at a slight incline. This drawing shows the two identical parts fused together with a gap between the two parts that are threaded.

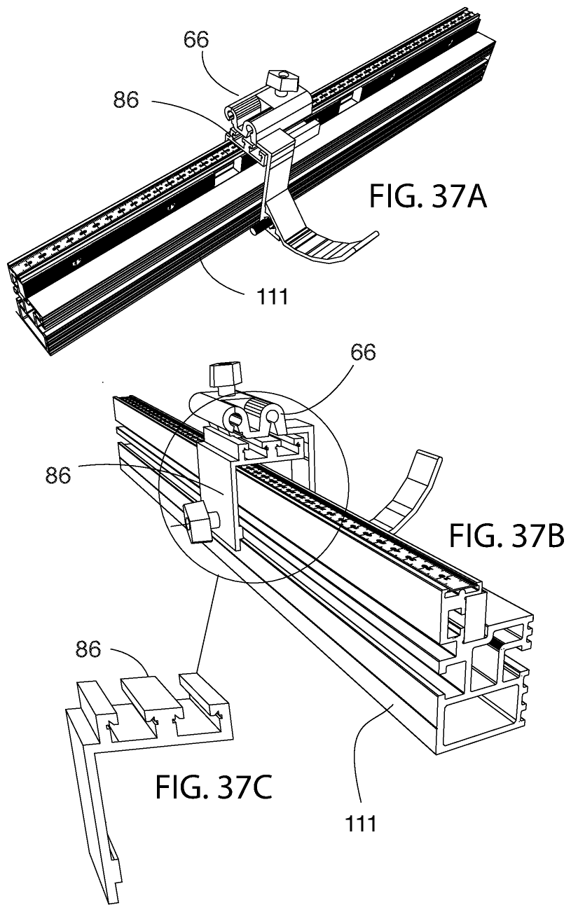

FIG. 37A illustrates the INCRA table saw miter gauge extrusion 111 with the curved flip stop 66 attached to an L-shaped bracket 86 that bolts to the back of the extrusion 111. This provide a mechanism for a choice of flip stops from various manufacturers. FIG. 37B illustrates the INCRA table saw miter gauge extrusion 111 with the curved flip stop 66 fitted to an L-shaped extrusion 86 with a double T-slot top and a flange on the opposite leg that fits into a T-slot on the back of the INCRA extrusion to provide adjustment of the flip stop 66 along the extrusion 111 (and that can be selectively secured via the shown fastener system). FIG. 37C is an enlargement of an example L-shaped connector bracket 86, similar to that shown in FIG. 37B (with the fastener opening not depicted).

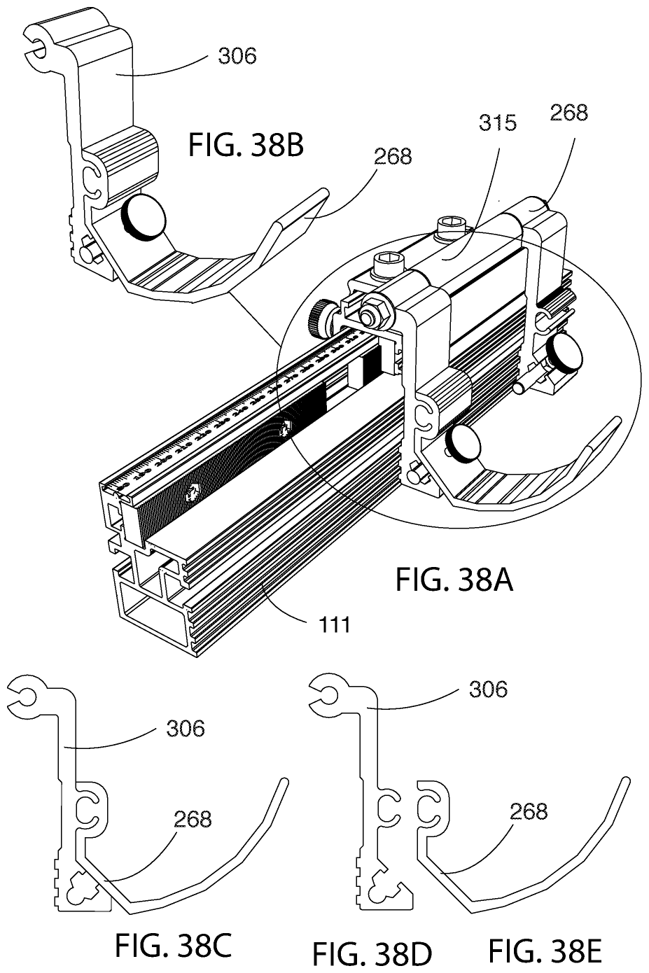

FIG. 38A illustrates the INCRA table saw miter gauge extrusion 111 with the INCRA flip stop 306 fitted with a curved extrusion 268 to make it a curved flip stop. FIG. 38B is an enlargement of the INCRA flip stop 306 and the curved flip stop accessory 268. FIG. 38C is an end view of the INCRA flip stop 306 and the curved flip stop accessory 268, with the parts shown touching each other. FIG. 38D is an end view of the INCRA flip stop 306 and FIG. 38E is an end view of the curved flip stop accessory 268. One preferred use for the curved accessory 268 is illustrated in FIG. 38A with the curved flip stop positioned for use for a final cut. A first cut that is used to square the board and remove planer snipe is often made with the standard stop.

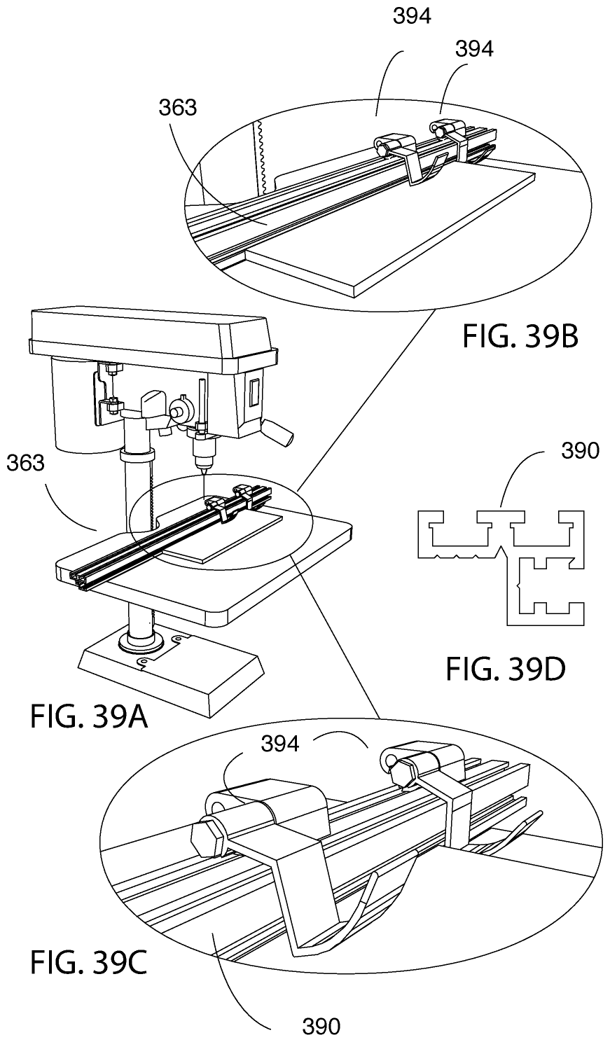

FIG. 39A shows a drill press 363 and an auxiliary table to enlarge the working surface fitted with an extruded fence 390 with curved flip stops 394 attached to the extrusion 390. FIG. 39B is an enlargement of the curved flip stop accessories 394. FIG. 39C is an enlargement of the curved flip stop accessory 394 in contact with the workpiece board. FIG. 39D is an end view of the fence extrusion 390 illustrated in FIG. 39A. Given the benefit of this disclosure, one skill in the art will appreciate the various inventive concepts herein can be adapted for use with a drill press configuration, as well as various other woodworking machinery.

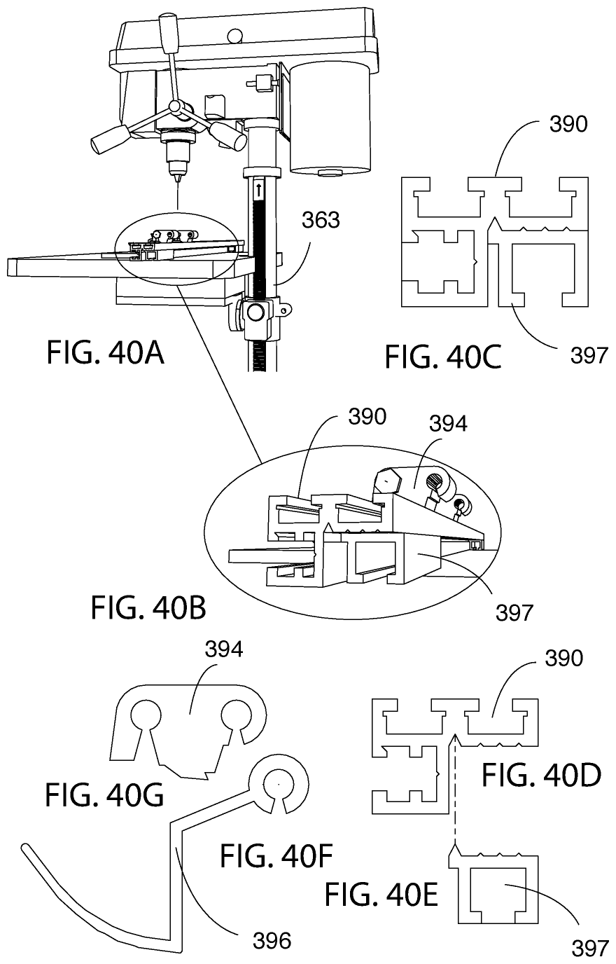

FIG. 40A shows a drill press 363 and an auxiliary table fitted with an extruded fence 390 with curved flip stops 394 attached to the extrusion 390—the perspective is from the back of the drill press 363. FIG. 40B is an enlargement of the extrusion 390 and the example curved flip stop accessory 394. FIG. 40C is an end view of the fence extrusion 390 illustrated with another T-slot extrusion 397 added to create a rectangular extrusion. FIGS. 40D and 40E are end views of the fence extrusion 390 illustrated with another T-slot extrusion 397 aligned for addition to create a rectangular extrusion. FIG. 40F is an end view of the curved flip stop extrusion 396 and FIG. 40G is an end view of the flip stop base extrusion 394.

FIG. 41A is a perspective view of a KREG K 4 pocket hole jig 10 with a clamp-on U-shaped fixture 56 that supports an H-shaped swing stop 216. In one example embodiment, an adjustment bolt for the stop 216 is held in place by a round magnet 27 that is in contact with the metal base of the clamp 10. The swing stop arm 216 is attached to the U-shaped fixture 10 with a bolt through a hole in the middle of the swing stop 216. The stop body 216 is hanging at a 45 degree angle and acts as a position stop with the end of the panel touching the stop arm 216. The stop 216 defines a J-shaped opening 172 with opposite ends from which the stop arm 216 can hang. On the left end (toward the center of the stop arm 216) of the opening 172, the stop arm 216 is configured to hang naturally at an angle (i.e., based on the designed center of mass of the stop arm 216 relative to the ends of the opening 172 from which it hangs). When hung from the right end (toward the end of the stop arm 216), the stop arm 216 is configured to hang naturally in a vertical orientation (e.g., as depicted in FIG. 41D). FIG. 41B is an enlargement of the adjusting bolt and magnet 27 shown in FIG. 41A. FIG. 41C is an enlargement of the flip stop arm 216 shown in FIG. 41A. FIG. 41D is a quarter inch grid 38 showing the design and size of the example embodiment of the flip stop arm 216. FIG. 41E is an enlargement of the flip stop arm with an approximate of the center of gravity illustrated with an arrow. FIG. 41F is an enlargement of the approximate center of gravity illustrated with an arrow.

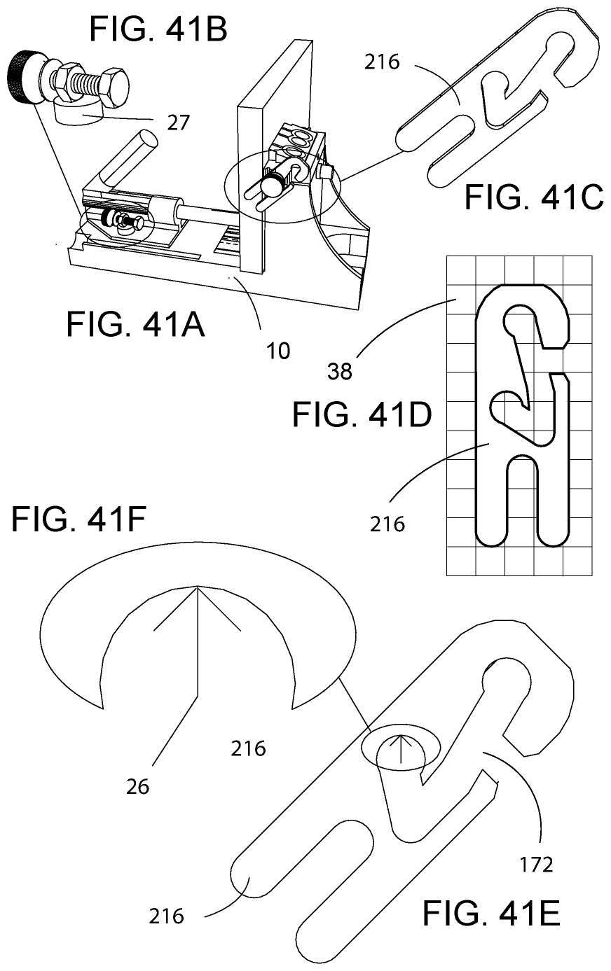

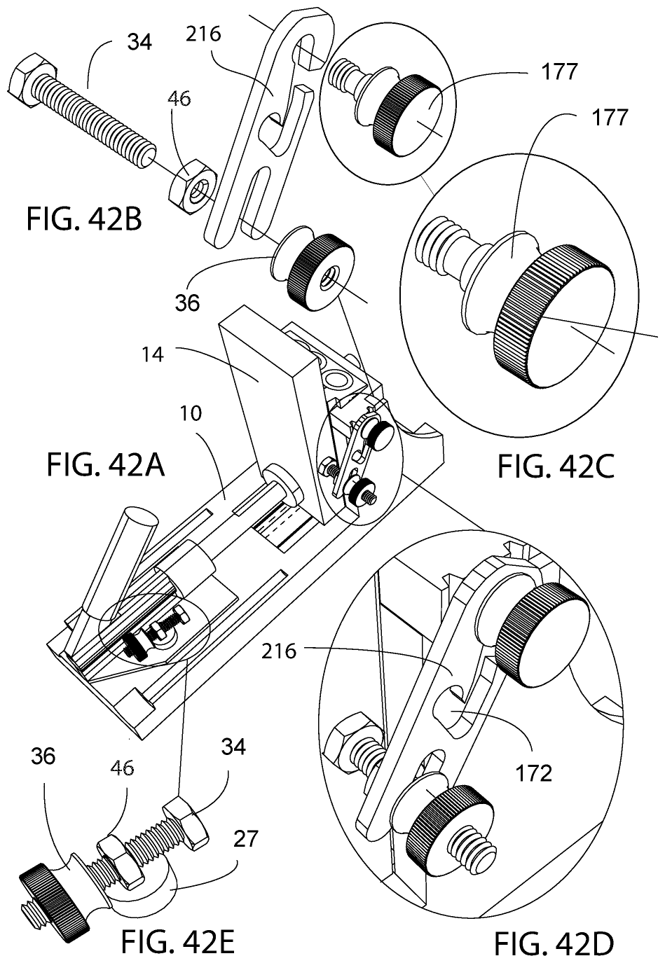

FIG. 42A is a perspective view of a KREG K 4 pocket hole jig 10 with a clamp on U-shaped fixture 56 that supports an H-shaped flip stop 216. An adjustment bolt 34 is positioned in the opening at the bottom of the flip stop arm 216. FIG. 42B is an exploded enlargement of the adjusting bolt 34, flip stop arm 216, and the double shoulder bolt 177. FIG. 42C is an enlargement illustrating the example embodiment of the double shoulder bolt 177. FIG. 42D is an enlargement illustrating the flip stop arm assembly 216 and the J-shaped opening 172. FIG. 42E is an enlargement of the adjusting bolt 34 and magnet 27 shown in FIG. 41A.

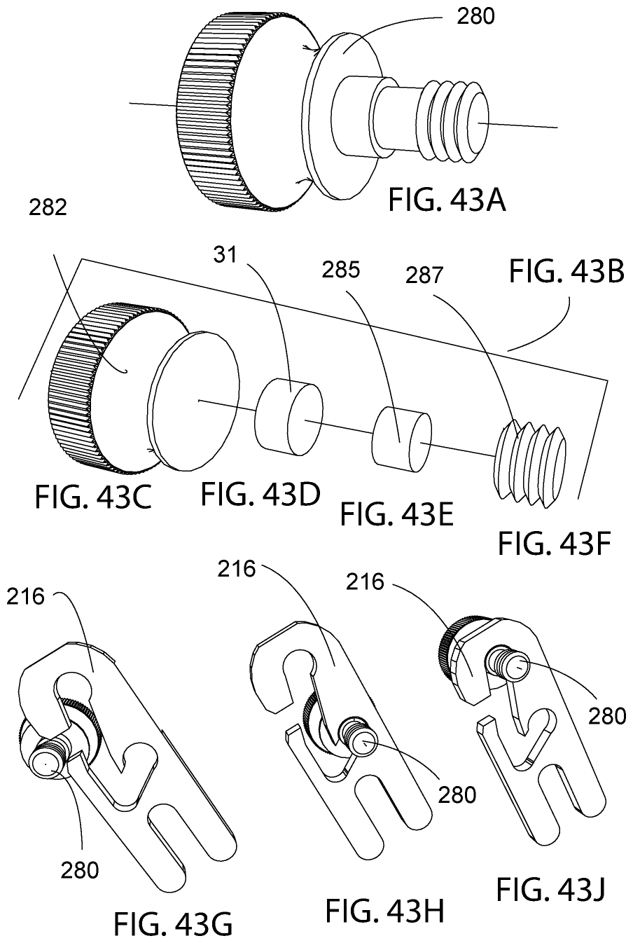

FIG. 43A is a perspective view of the example double shoulder bolt 280 that can be used with the various flips stops. FIG. 43B is an exploded, fragmented view of the double shoulder bolt 280 illustrated in FIG. 43A. The segments of the bolt 280 are separated for clarity, such as the thumb nut head portion 282 (FIG. 43C), the larger shoulder portion 31 (FIG. 43D), the smaller shoulder portion 285 (FIG. 43E), and the threaded portion 287 (FIG. 43F). The bolt 280 can be inserted into the J-shaped opening 172 and positioned at both ends of thereof, as illustrated in FIGS. 43G-43J. FIG. 43G is a perspective view of the smaller shoulder 285 fitting into the slot 172 in the flip stop arm 216. FIG. 43H is a perspective view of the larger shoulder 31 positioned and fitting into the hole proximate the middle of the flip stop arm 216. FIG. 43J is a perspective view of the larger shoulder 31 positioned and fitting into the hole proximate the end of the flip stop arm 216.

The bolt 280 is further illustrated with reference to FIGS. 44A-44G. FIG. 44A is a perspective view of a double shoulder bolt 280. FIGS. 44B and 44C are an exploded, segmented view of the double shoulder with the small shoulder 285 located in the slot 172 in the body of the flip arm 216. FIG. 44D is a perspective view of the smaller shoulder 285 positioned near the opening into the slot 172 in the flip stop arm 216. FIG. 44E is an enlargement of FIG. 44D. FIG. 44F is a perspective view of the double shoulder bolt 280 with the smaller shoulder 285 located in the slot 172 in the body of the flip arm 216, and FIG. 44G is an enlargement of FIG. 44F.

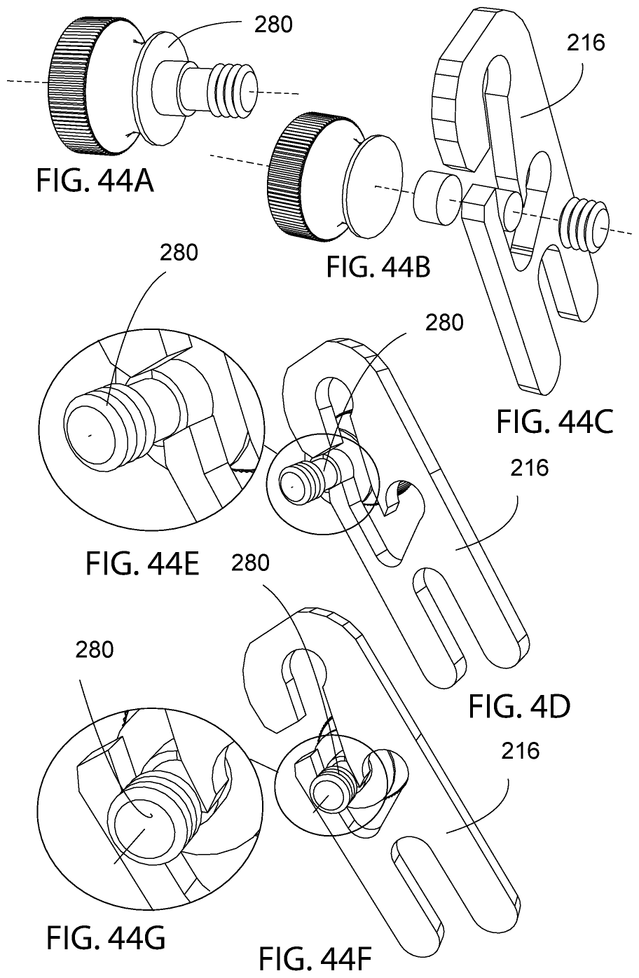

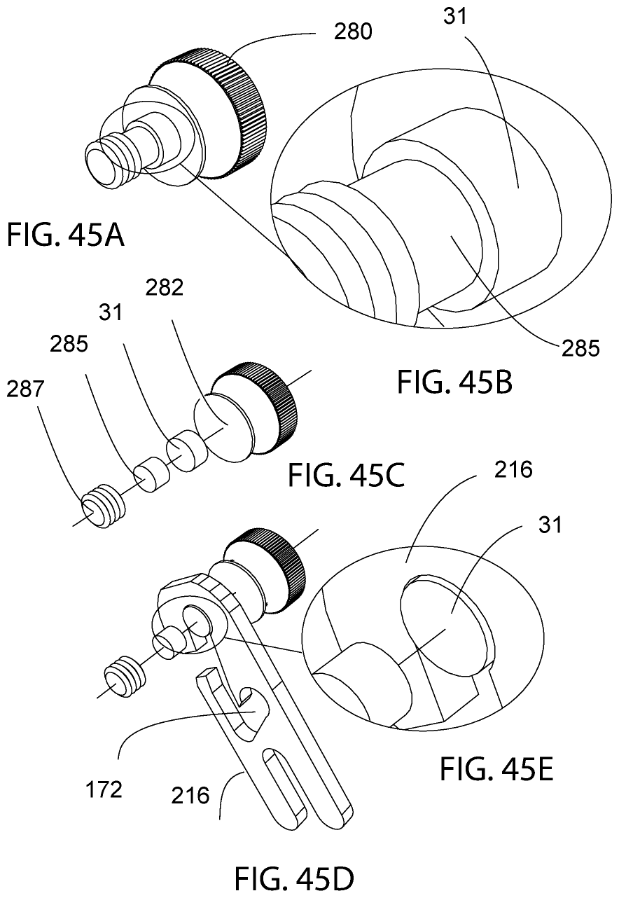

FIG. 45A is a perspective view of the example embodiment of the double shoulder bolt 280. FIG. 45B is an enlargement of FIG. 45A showing the larger shoulder 31. FIG. 45C is another exploded view of the double shoulder bolt 280 illustrating the various segments. FIG. 45D is an exploded, segmented view of the double shoulder bolt 280 with the larger shoulder 31 located in an outside hole in the body of the flip arm 216, that is, at the end of the J-shaped slot 172 proximate an end of the flip arm 216. FIG. 45E is an enlargement of FIG. 45D showing the larger shoulder 31 located in an outside hole in the body of the flip arm 216. As one of skill in the art will appreciate when given the benefit of this disclosure, the bolt may take on a variety of different forms while accomplishing the various functional aspects described herein.

There are a number of flip stop and a track manufactures that incorporate an aluminum T-slot extrusions (e.g., T-slot 79) to secure the stop base to the track. Aluminum extrusions are manufactured when an aluminum extrusion is heated to a formable semi-firm state and then pushed/forced through a die opening. The extrusion process is generally efficient but not completely accurate. If an exact measurement is required for an end use, the extruded shape is made to an oversized form factor and then precision machined to an exact final shape. To avoid the extra expense and secondary machining, many of the current major track and stop manufactures, such as KREG, INCRA, and ACCU-MITER, employ and use standard extrusions. Aluminum manufacturers are constantly monitoring the extrusion size and adjusting the speed of the extrusion press/process to maintain (as close as practical) the desired final product shape. In practice, however, the extruded aluminum material (e.g., the T-slot 79 extrusion) may vary in size, especially with the smaller T-slot shapes. Within the same aluminum extrusion batch the T-slot may vary in width by as much (or more) than 0.025 inches.

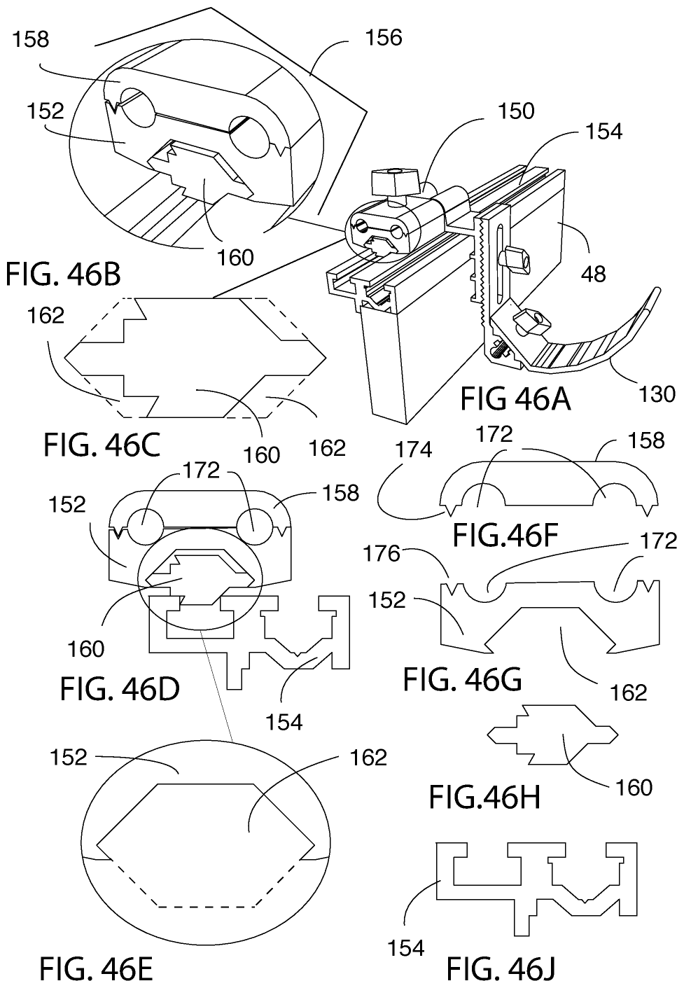

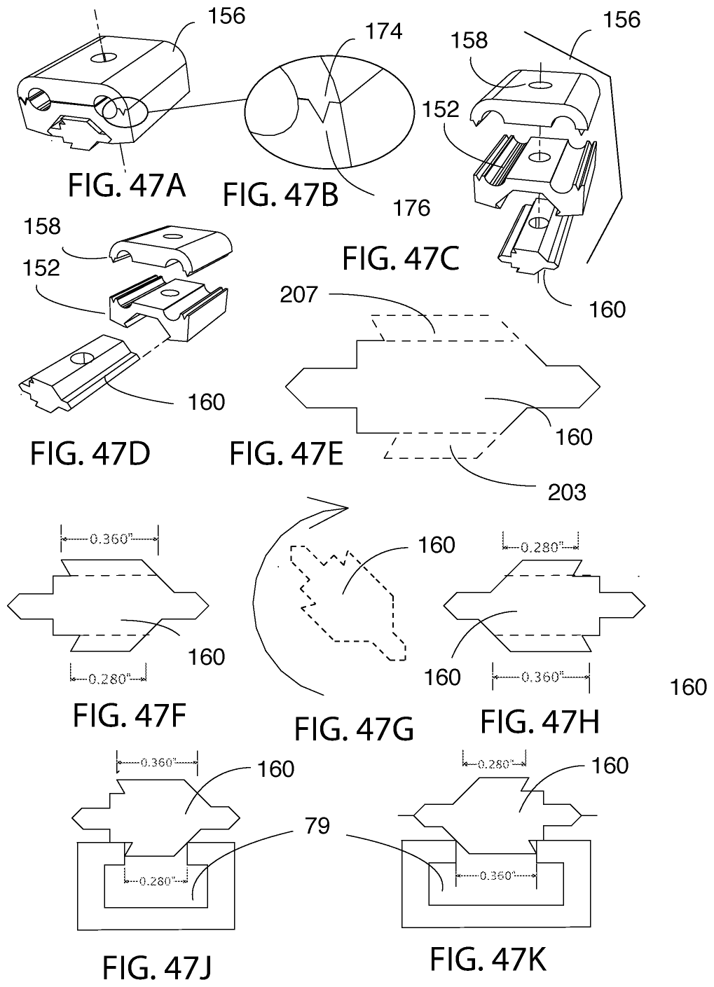

FIGS. 46A-47K illustrate how aspects of embodiments of the invention allow the base of the flip stop arm to adjust to a variety of T-slot widths, which may accommodate manufacturing variability, differing manufactures, and other variables. FIG. 46A is a perspective view of a flip stop 150 attached to a T-slot extrusion 154 mounted on a board 48. The leg of the flip stop arm is fitted with an optional curved extrusion 130 that elevates the flip stop to a stand-by position when a workpiece board is against it and contacting the curve, which urges the curved arm 130 to rotate and pivot over the top of the board 48. FIG. 46B is an enlargement of FIG. 46A illustrating an embodiment of the adaptor assembly 156 having the example modified hexagon adaptor 160 that connects (and interfaces) the flip stop bottom 152 to the track extrusion 154. FIG. 46C is an enlarged end view of the modified hexagon adaptor 160 that connects the flip stop bottom 152 to the track extrusion 154. FIG. 46D is an end view of the flip stop top 158, flip stop bottom 152, and adaptor 160 of the adaptor assembly 156. Also shown is the track extrusion 154 that the modified hexagon shape 160 contacts. FIG. 46E is an enlargement end view of the example extrusion profile defined by the base extrusion 152 shown in FIG. 46D. In the example embodiment, the bottom extrusion 152 defines a partial hexagon shaped opening 162 (shown with a solid line). With reference to FIGS. 46F and 46G, FIG. 46F is an end view of the top half 158 of the adaptor assembly 156 and FIG. 46G is an end view of the middle extrusion forming the flip stop bottom 152 of the adaptor assembly 156. The flip stop top 158 further includes two slightly elongated half hole shapes 172 and V-shaped flanges 174 that are located between the holes and outside edge. The flip stop bottom 152 also further includes two slightly elongated half hole shapes 172 and mating V-shaped grooves 176 that are located between the holes and the outside edge. The V-shaped flanges 174 and the V-shaped groves 176 are configured to generally align and engage when the flip stop top 158 and the flip stop bottom 152 are aligned and assembled (various other structures may be provided to accomplish the alignment function). An end view of the extrusion forming the example adaptor 160 that is configured to fit into and engage the track extrusion 154 is shown in FIG. 46H. And, FIG. 46H illustrates an end view of the T-slot track extrusion 154.

Turning to FIGS. 47A-47K, aspects of the adaptor assembly 156 are described in more detail. FIG. 47A is a perspective view of an example embodiment of the adaptor assembly 156. FIG. 47B is an enlarged view of a portion of the adaptor assembly 156 shown in FIG. 47A illustrating the outside corner with the V-shaped flange 174 engaged with the V-shaped groove 176. FIG. 47C is an exploded view of FIG. 47A illustrating the flip stop top 158, the flip stop bottom 152, and the adaptor 160 of the example adaptor assembly 156. FIG. 47D is an exploded view illustrating the top 158, the bottom 152, and the adaptor 160 (shown translated from under the bottom 152 and aligned with the opening 162 in the bottom 152). In the example embodiment, the adaptor 160 and the bottom 152 are configured such that the adaptor 160 is inserted laterally into the opening 162 in the bottom 152, such that the adaptor 160 and the bottom 152 are not readily separated, unless slid laterally. In one embodiment, the form factor of the opening 162 may be configured (e.g., keyed) to accept the form factor (e.g., profile) of the adaptor 160. Given the benefit of this disclosure, one skilled in the art will appreciate the alternative arrangements to selectively couple the bottom 152 and the adaptor 160. FIG. 47E is an end view of the modified hexagon adaptor 160 that connects and interfaces the flip adaptor assembly 156 (and coupled flip stop 150) to the track extrusion 154. The two different example parallelograms are illustrated with dotted lines, the larger parallelogram 207 is larger than the smaller parallelogram 203 to accommodate variable track widths. FIG. 47F is an end view of the modified hexagon adaptor 160. The larger parallelogram 207 can be 0.360 inches in length and the smaller parallelogram 203 can be 0.280 inches in length. This illustration shows the smaller parallelogram 203 is on the bottom for track engagement. FIG. 47G is an end view of the modified hexagon adaptor 160 illustrating that the adaptor 160 can be rotated so that either the larger parallelogram 207 or the smaller parallelogram 203 can be oriented to interface with the T-slot track (e.g., T-slot 79). FIG. 47H is an end view of the modified hexagon adaptor 160 after rotation, again with the larger parallelogram 207 being 0.360 inches in length and the smaller parallelogram 203 being 0.280 inches in length, with the larger parallelogram 207 being on the bottom and oriented for track engagement. FIG. 47J is an end view of the modified hexagon adaptor 160 with the smaller parallelogram 203 on the bottom and positioned on the T-slot track 79 that was extruded with a slightly smaller track opening. For instance, this is the example arrangement that may be for using the flip stop 150 on smaller T-slot models, such as the KREG or ACCU-MITER configurations. FIG. 47K is an end view of the modified hexagon adaptor 160 illustrating the larger parallelogram 207 on the bottom and positioned for engagement with a T-slot track 79 having a larger slot opening. This is the example arrangement for using the flip stop 150 on wider T-slot models such as the INCRA.

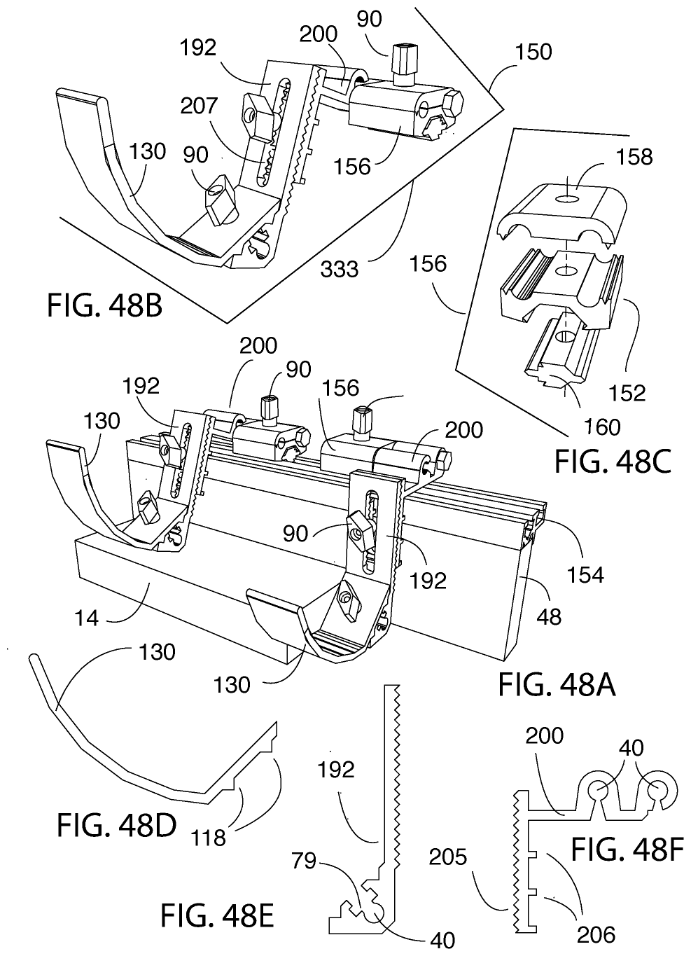

FIG. 48A is a perspective of the flip stop 150 and T-slot track 154 illustrated in FIG. 46A. The illustration shows two flip stops 150. The flip stop 150 in the foreground is in the functional position with the workpiece 14 in contact with it. The flip stop 150 in the background is resting on the workpiece 14 in the stand-by position. FIG. 48B is an enlarged perspective of one of the flip stops 150 illustrated in FIG. 48A. The flip stop L-extrusion 200 is bolted to the flip stop base (also referred to as the adaptor assembly 156). FIG. 48C is an exploded view of the adaptor assembly 156 illustrating the top 158, the bottom 152, and the adaptor 160 (e.g., a modified hexagonal adaptor) of the flip stop adaptor assembly 156. FIG. 48D is an end view of the curved stop accessary 130. And, FIG. 48E is an end view of the extension leg 192. FIG. 48F shows an end view of the L-shaped flip stop arm 205.

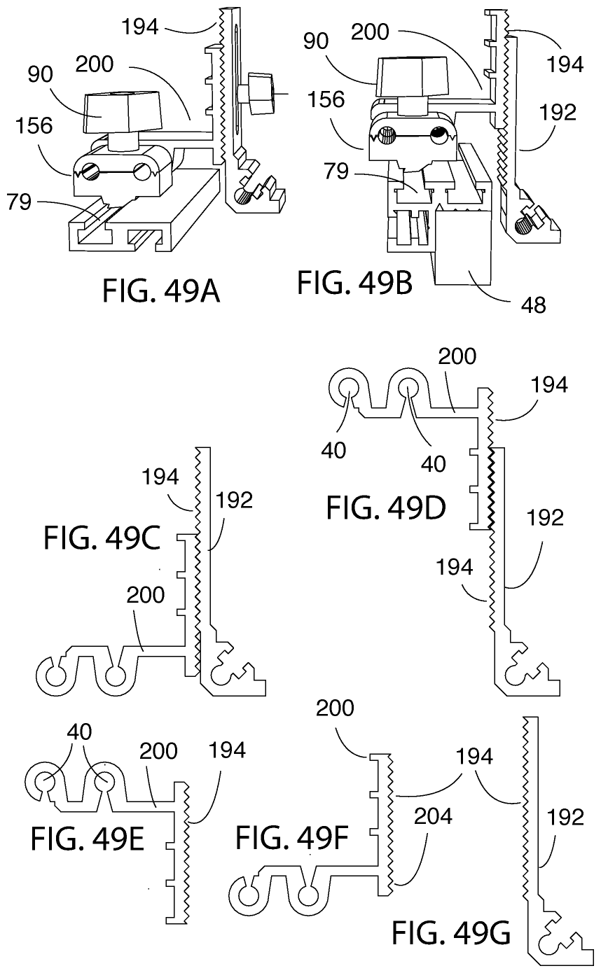

FIG. 49A is a perspective of a portion of the flip stop 150 attached to a small track T-track 79. The example L-shaped flip stop arm 200 is positioned so that the leg is oriented upward. FIG. 49B is a perspective of the flip stop 150 attached to a small track T-track 79 with the example L-shaped flip stop arm 200 is positioned so that the leg is oriented upward. The L-shaped arm extension 200 is extended to accommodate the T-slot 79 extrusion and the support board 48. FIG. 49C is an end view of the L-shaped flip arm 200 in contact with the extension leg 192. The mating teeth 194 on each piece are configured to mesh when in contact with each other, and to allow relative adjustment of the overall extension provided by the extension leg 192. FIG. 49D is an end view of the L-shaped flip arm 200 in contact with the extension leg 192. The mating teeth on each piece 194 are in contact with each other. This illustration shows the L-shaped flip arm 200 with the toothed leg 192 oriented downward with the extension leg 192 extended (e.g., indexed lower relative to the arm extension 200) to accommodate a higher fence. FIG. 49E is an end view of the L-shaped flip arm 200 illustrating the L-shaped flip arm 200 with the toothed leg pointing downward. Open slot holes 40 are located in the arm portion that is opposite the teeth 194. FIG. 49F is an end view of the L-shaped flip arm 200 illustrating the L-shaped flip arm 200 with the toothed leg pointing upward. Again, holes 40 are located in the leg opposite the teeth 194. FIG. 49G is an end view of the extension leg 192 with the teeth 194 located along the vertical side. In one embodiment, the teeth (or other mating structures) allow the relative positioning of the arm extension 200 and extension leg 192 to be altered (e.g., by loosening an adjustment fastener and repositioning at least one of the extensions, such as by separating and moving one of the extensions along a slot that is captured by a thumb knob fastener and tightening the fastener to secure the extensions in the new orientation).

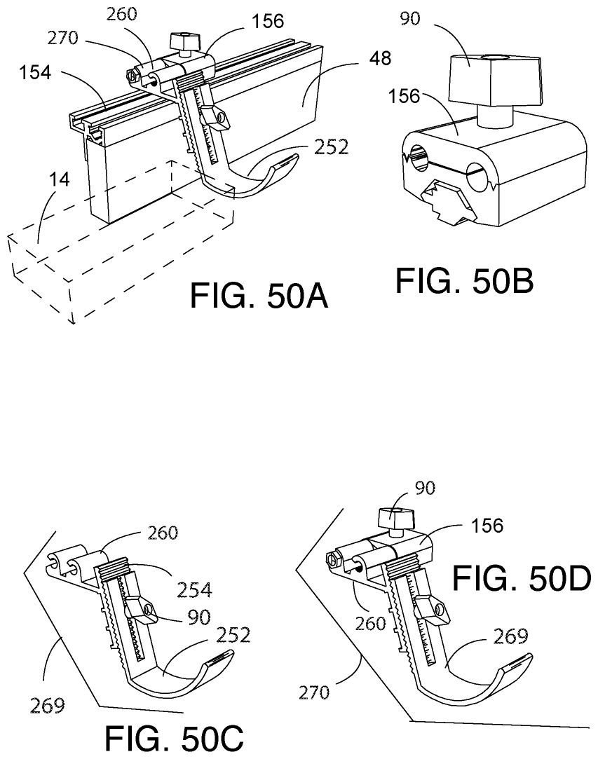

FIG. 50A is an illustration of woodworking machines flip stop 270 position on an extruded aluminum fence 154 functions as a measuring system for a woodworking machine. An example embodiment of the adjustable three part adaptor assembly 156 is shown in FIG. 50B and has been described earlier in this application. The flip stop arm 260 is angled at approximately 20 degrees, in one embodiment. The leg with a curved foot 252 is attached to the flip arm 260 with a bolt or similar fastener 90. FIG. 50C is a perspective view of the two pieces of the flip stop arm 269 removed from the fence extrusion 154 and the adaptor assembly 156. The parts can be secured relative to each other via a bolt and a knob 90 arrangement. In the example embodiment, the flip arm 260 and the curved foot leg 252 have mating 45 degree angle teeth 254 clamped together with a knob 90. FIG. 50D is perspective view of the flip stop assembly 270 illustrated in FIG. 50A removed from the extrusion 154 and engaged with the adaptor assembly 156. The flip stop arm 269 can be comprised of two adjustable pieces with mating corrugations (e.g., teeth) on each piece. A bolt can extend from the inside of the angled arm 260 and pass partially through an open ended slot in the curved foot 252, such that the corrugations in each piece can be sighted separated, moved, realigned, and reengaged into a solid flip stop arm. The curved foot 252 allows the operator to push the workpiece under the stop 269 to elevate the stop 269 out of the way when not needed.

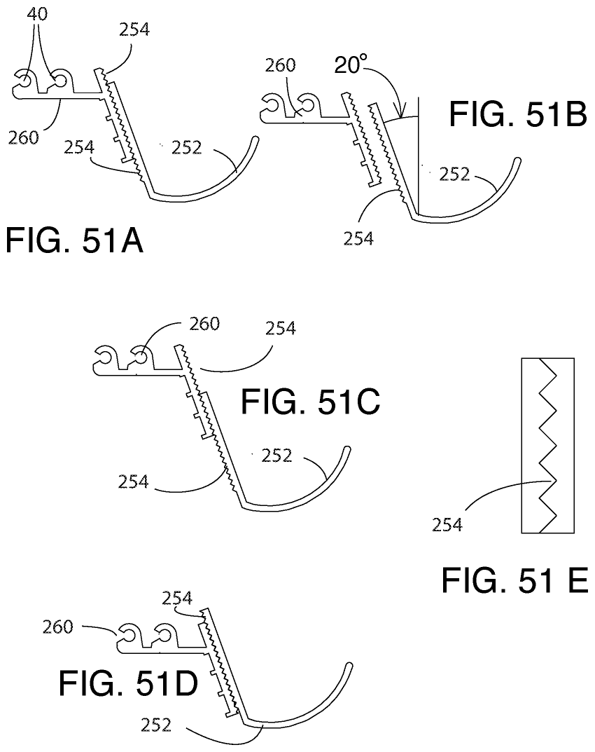

FIGS. 51A-D and illustrate how the two flip arm members mate with each other and provide overall adjustment of the pivot arc and extension length. FIG. 51A is an end-view of the example embodiment stop arm piece shown in FIG. 50. The flip stop arm 260 has two open-sided holes 40 and an angle leg with mating teeth 254. The curved leg piece 252 has teeth 254 that mate with the teeth 254 of the flip stop arm 260. FIG. 51B is a view of the pieces shown in FIG. 50A with the pieces separated from each other and illustrating an example angle at which the curved leg piece 252 may form. FIG. 51C is an end view of the stop arm pieces shown with the two pieces joined in a way to extend the overall length and arc of the stop arm for use with a higher fence or to accommodate other application-specific requirements. FIG. 51D is an end view of the stop arm pieces shown with the two pieces joined in a way to shorten the overall length and arc of the stop arm for use with a lower fence or to better accommodate other application-specific requirements. FIG. 51E is an enlarged view of the teeth 254 inter-fitting together.

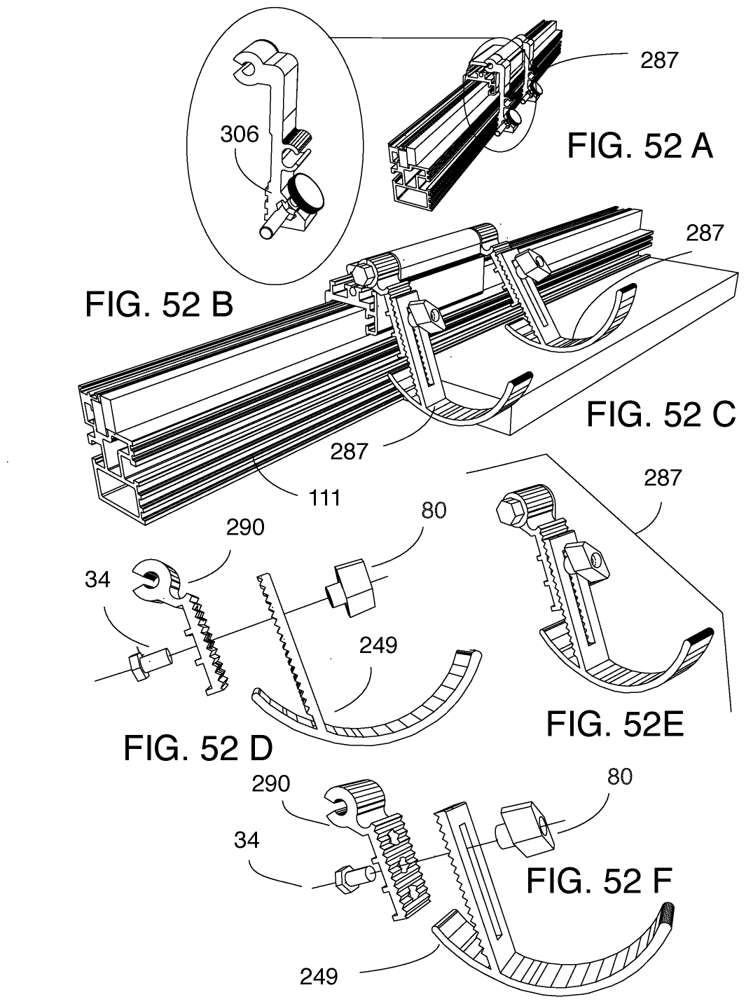

FIG. 52A is a perspective view of the INCRA miter gauge fence and stop system. FIG. 52B is a detail view of an INCRA flip stop arm 306. FIG. 52C illustrates the adjustable-in-length self-elevating flip stop design 287 in FIGS. 50 and 51 adapted to INCRA miter gauge fence and stop system. The flip arm is not connected to the INCRA base in this illustration. The two INCRA flip stop arms have been replaced by two curved arms 249. The curved bottom extrusion 249 is similar to that shown in FIGS. 51 and 52. The upper connecting extrusion has a similar half oval design as the INCRA flip arm base. FIG. 52D is an exploded perspective view illustrating the matching corrugations and shape of the single hole flip stop arm 290 configured to replace the standard INCRA flip stop arm 306. FIG. 52E is a modified end-view of the flip stop arm extrusions and illustrates a flip stop design 287 that has a single hole flip stop arm 290. The configuration of the flip stop arm allows it to replace the standard INCRA fill stop arm 306. The curved flip stop leg 249 can be 0.75 inches wide, which is similar to the standard INCRA flip stop 306. FIG. 52F is an exploded perspective view illustrating the matching corrugations.

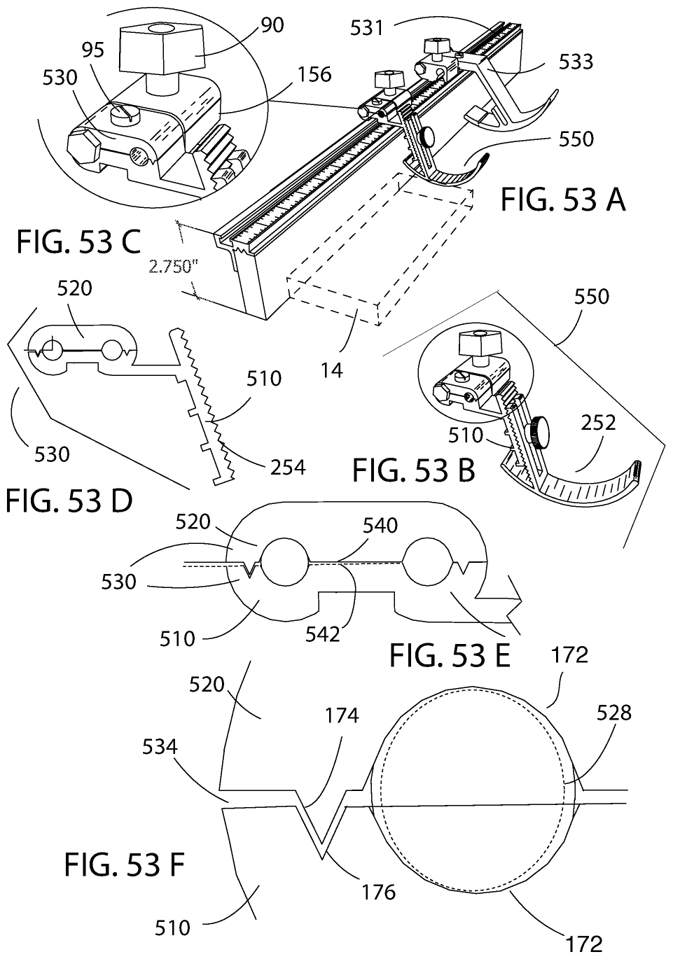

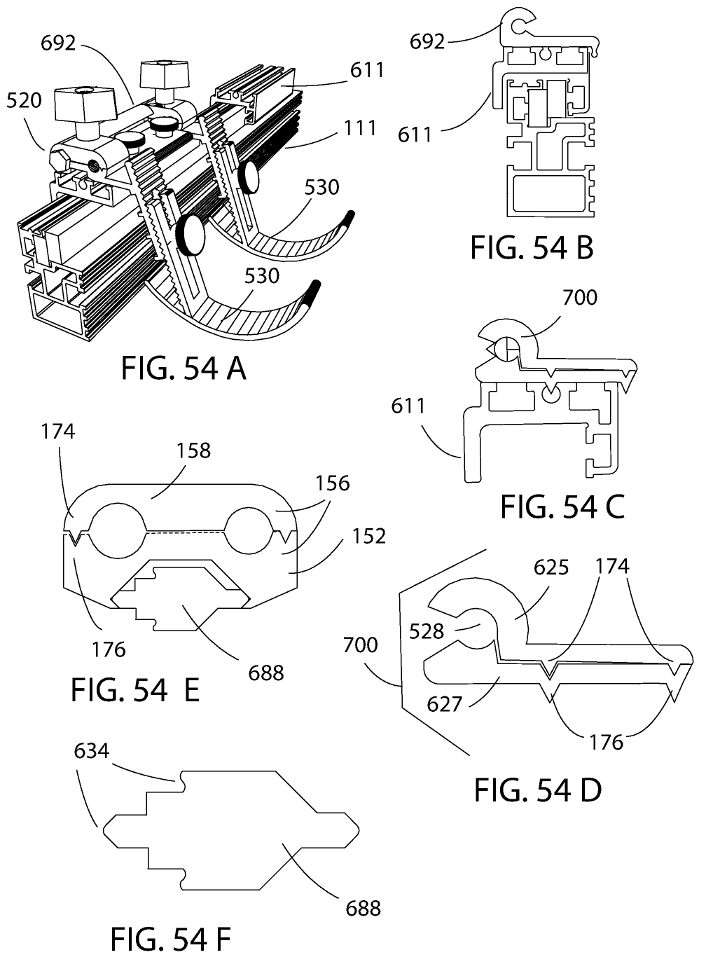

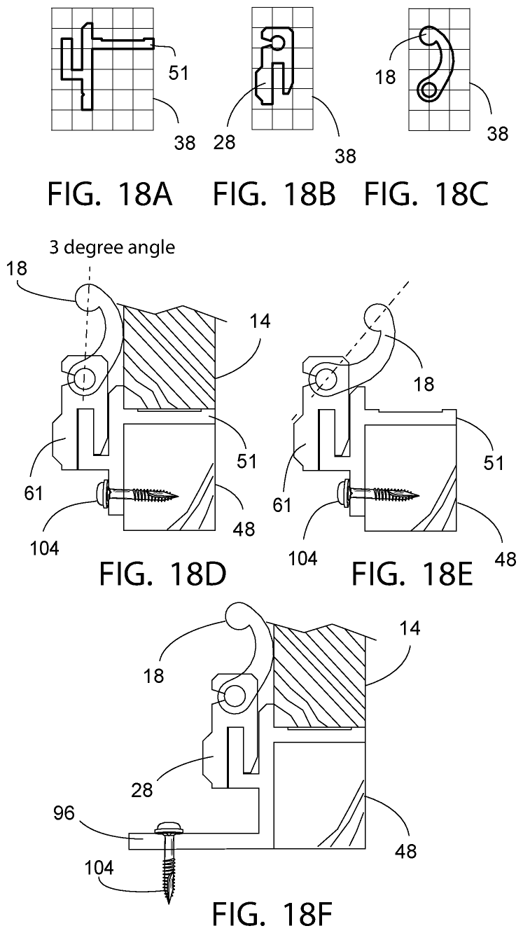

FIG. 53A is an illustration of the universal flip stop 550 attached to the KREG top track 531. Also shown in the illustration is the KREG flip stop 533. A workpiece 14 is in contact with the curve bottom 252 of the universal flip stop 550. FIG. 53B shows the universal flip stop 550 removed from the fence. The flip stop arm 510 is secure to the curved leg 252, such as via indexed teeth and mating fastener assembly. FIG. 53C illustrates an adjustable flip stop base adaptor assembly 156 attached to flip stop arm 530. The clamp feature of the flip stop base adaptor assembly 156 is described in detail earlier in this patent application. The flip stop arm 530 uses a similar example clamp design as the flip stop base 156. The flip stop arm top 520 has a similar profile as the flip stop top 158. Rather than using a knob 90 the clamping is accomplished with a small screw 95 that may engage a threaded hole (not shown). FIG. 53D is an end view of the flip stop arm assembly 530 illustrating the profile of the flip stop top 520 arm and the flip arm leg 510, and the teeth 254 along the leg 510. FIGS. 53E and 54E are enlargements of a portion illustrating the gap 534 between the flip stop top 520 and the flip stop arm 510 (or bottom) when the two extrusions are tighten on the bolt represented by the round dotted line 528. Thus, the flip stop arm assembly 530 can be selectively rotated about the bolt during use. The form factor of the generally half circles 172 can be, in one embodiment, configured to establish a slightly oblong opening when the flip stop top 520 and the flip stop arm bottom 510 are brought into proximity. Furthermore, the top 520 and bottom 510 include V-shaped structures 174, 176 to aid alignment. While the lower interface surface of the flip stop top 520 is generally horizontal (as viewed in FIG. 53D), the upper interface surface of the flip stop bottom 510 may define a slight taper as illustrated by dotted line 542 to help establish the gap 534.

FIG. 54A is an illustration of the INCRA fence 111 with two universe flip stop arms 530 mounted on the INCRA double T-slot extrusion 611. FIG. 54B is an end view of the INCRA flip stop base 692 on top of the INCRA double T-slot track 611. FIG. 54C is an enlarged view of the INCRA double T-slot track 611 with a two piece clamp base 700 using the clamping mechanism similar to that described above. FIG. 54D is an enlarge view illustrating the clamping stop base 700. The clamping stop base 700 includes a top 625 that has the mating V-shaped flange similar to the flange on the bottom of the top 158 of the flip stop adaptor assembly 156. The clamp base 627 has the mating V-shaped groove similar to the bottom 152 of the flip stop adaptor assembly 156. FIG. 54E is an end view of another example adaptor assembly 156. The example adaptor assembly 156 is a two-piece clamp style stop base, similar to the base illustrated in FIG. 46D, depicting one of the bolt holes as larger than the other. For example, the smaller hole may accept and squeeze a ¼ inch bolt and the larger hole may accept and squeeze a 5/16 inch bolt. The example modified hexagon adaptor 160 is replaced with a similar adaptor 688 incorporating rounded corners 634. As the aluminum extrusion dies wear, sharp corners become rounded. Thus, by starting out with rounded corners, the extrusion maintains the original shape for a longer period of time avoiding the expense of a new extrusion die. FIG. 54F is an enlarged view of the modified hexagon adaptor 688 design with rounded corners 634. Given the benefit of this disclosure, one of skill in the art will appreciate the various form factors that the example adaptor embodiments described herein may take, such as, for instance, a modified end profile with arcuate, rounded, jagged, squared, etc. surfaces and boundaries.

Preferred embodiments of the invention have been described in considerable detail. Given the benefit of this disclosure, one skilled in the art will appreciate the many modifications and variations to the preferred embodiment described. Therefore, the invention should not be limited to the embodiment described.

I claim:

1. A flip stop assembly, comprising:
a top portion;
a bottom portion adjacent the top portion and selectively coupleable to the top portion to define a pivot; and
a flip stop member coupled to at least one of the top portion and the bottom portion and configured to rotate about the pivot.

2. The flip stop assembly of claim 1, wherein the flip stop member comprises:
an arm; and
a leg; and
wherein the arm and the leg are selectively coupleable.

3. The flip stop assembly of claim 2, wherein:
the arm defines a first interlocking structure; and
the leg defines a second interlocking structure; and
wherein the first interlocking structure and the second interlocking structure can be engaged in a first orientation that defines a first pivot arc of the flip stop member and a second orientation that defines a second pivot arc of the flip stop member that is different from the first pivot arc.

4. The flip stop assembly of claim 2, wherein:
the arm defines an opening; and
the leg defines a slot; and
wherein a fastener assembly extends partially through the opening and the slot and is configured to secure the arm relative to the leg.

5. The flip stop assembly of claim 1, further comprising an adaptor adjacent the bottom portion and configured to engage with the bottom portion and be mountable within a track.

6. The flip stop assembly of claim 5, wherein the adaptor defines a top form factor and a bottom form factor that is distinct from the top form factor to allow the adaptor to interface with tracks of different form factors.

7. The flip stop assembly of claim 1, wherein the bottom portion defines an opening sized to laterally receive the adaptor.

8. The flip stop assembly of claim 7, wherein the opening is keyed to a profile of the adaptor to permit lateral insertion of the adaptor into the opening.
